(19) United States
(12) Patent Application Publication
(10) Pub. No.: US 2006/0254973 A1
(43) Pub. Date: Nov. 16, 2006

(54) Filter

(76) Inventors: Ole Olsen, Charlottenlund (DK); Lise Nohr Larsen, Charlottenlund (DK)

Correspondence Address: GIFFORD, KRASS, GROH, SPRINKLE & CITKOWSKI, P.C, PO BOX 7021, TROY, MI, 48007-7021, US

(21) Appl. No.: 10/563,346

(22) PCT Filed: Jul. 2, 2004
(86) PCT No.: PCT/DK04/00474

§ 371 Date: Jun. 5, 2006

(30) Foreign Application Priority Data
Jul. 2, 2003 (DK) PA 2003 01002

(51) Int. Cl. B01D 29/00

(52) U.S. Cl. 210/338; 210/450

(57) ABSTRACT

The present invention relates to a filter for liquid filtration, the construction of the filter ensure increased filtration capacity by using up the filtration medium rather that clogging up. The filter comprises layers of filtration medium (2) and optionally also layers of spacer medium (1). Liquid to be filtered can through bypass spaces circumvent a number of layers of filtration and/or spacer medium and is by at least one sealing (3) directed through the filtering area of filtration medium. End caps (5) with perforations (6) allow the liquid to be distributed within the bypass space between the edges of the layers of filtration medium and spacer medium. Rolled filters with a central core (4) to drain off the filtered liquid can be constructed in large dimensions. Also disclosed is a method making the filter. The filters are suitable for many purposes, especially for filtering liquid with oil.

### FIELD OF INVENTION

The present invention relates to a filter, a method of making a filter and a method of filtering a contaminated fluid. The invention particularly relates to a filter having a composition by which the filter is not clogged up due to deposit of contaminants within outer part of filtering media. All patent and non-patent references cited in the present application, are hereby incorporated by reference in their entirety.

### BACKGROUND OF INVENTION

Filters for removing contaminating components from liquid are known from the prior art. Filters are usually constructed to draw the fluid across one or more layers of a porous medium, hereby separating dispersed particles or compounds from a dispersing fluid.

Traditional filters suffer from the dilemma that on one hand they need to have an open structure in order to retain a certain hydraulic conductivity, but on the other hand the structure must not be too open in order to retain dispersed particles and compounds. Traditional filters also suffer from gradually falling hydraulic conductivity (pressure drop) as more and more particles are trapped within the filtration medium. Clogging rather than use-up of filter capacity often determines the frequency of filter regeneration or replacement.

The filter capacity of a filter has been increased by using alternating layers of filtering media and spacer media, hereby letting the contaminated liquid passing parts of the outer filtering media by running in the spacer media. When the contaminated liquid passes through the filter in the spacer media, some contaminants are adsorbed by the filtering material. The drawbacks of these filters are that although the filter capacity is increased, there is still a pressure drop as materials with low hydraulic capacity (and high absorptive capacity) are adsorbed to the outer layers of filtering media, hereby the liquid has a longer way in the spacer medium before it can enter through filtering media. With time the outer filter media is filled with contaminants, the flow capacity of the liquid through the filter is decreases as well as a pressure drop arises.

U.S. Pat. No. 4,299,702 (BAIRINJI ET AT.) describes a liquid separation apparatus of spiral type including a membrane module comprising a hollow mandrel having at least a hole, at least one pair of semipermeable membrane sheets and at least one pair of first and second spacing layers, where the membrane sheets and spacing layers being wound about the mandrel. The first spacing layer forms, with said membrane sheets, a first passage for a permeated solution to be discharged therefrom into the interior of said mandrel through the hole. The second spacing layer forms, with said membrane sheets, a second passage for a feed solution or a non-permeated solution. The membrane module has a first opening on the circumference and an axial opening in the vicinity of the mandrel.

U.S. Pat. No. 4,271,025 (ERDMANNSDORFER) describes a filter cartridge for a liquid-straining filter assembly designed for a radial flow-through. The cartridge has a coiled filter body which surrounds a perforated central sleeve and is axially confined between end discs. The coiled filter body consists of overlying layers of two axially offset strips of creped filter paper. The protruding spiral edges of the two coiled strips being glued to the end discs, while the recessed opposite edges form bypass flow gaps interconnecting the axial channel portions between the creped paper layers to form a zigzag-shaped transverse flow channel for depth-filtering action, when the entry layers of the cartridge become clogged.

U.S. Pat. No. 6,153,098 (BAYERLEIN ET AL.) describes fluid filter element which has a hollow perforate cylindrical supporting core. A relatively fine filter media of substantial cross section is spirally wound about the supporting core with adjacent layers spaced from each other and with the fine filter media accommodating fluid flow for filtering in both a radial and circumferential direction through the cross section and with free access through the cross section to the supporting core. In substantially the same manner, a relatively coarse filter media of substantial cross section is disposed in the space between the layers of fine filter media and with the coarse filter media exiting at the supporting core, the coarse filter media accommodating fluid flow for filtering in both a radial and circumferential direction through the cross section and with free access through the cross section to the supporting core. A central barrier is disposed adjacent the supporting core and at least one of the layers of filter media in approximately the center of the filter element to assist in the filtration process.

US 2001/0037982 A1 (PULEK ET AL.) and U.S. Pat. No. 6,391,200 (PULEK ET AL.) both claiming priority of U.S. provisional patent application Ser. No. 60/103,233 filed Oct. 5, 1998 describe a filter including alternating layers of filter medium and diffusion medium wherein at least a portion of the layers of filter medium (non-qualifying layers) have bypass apertures. The sheets of the filter medium and the diffusion medium are wrapped, or coiled, around an elongated, porous, rigid core having a multiplicity of openings. Annular end caps are bonded to the ends of the filter to prevent contaminated fluid from by-passing the filter. The bypass apertures in the filter medium allow a portion of the fluid to pass therethrough instead of passing through the filter medium of that particular layer. After passing through one of the non-qualifying layers of filter medium, the fluid passing through the bypass apertures and the fluid passing through the filter medium are re-mixed and diffused in the diffusion medium before being filtered by the next layer of filter medium. Preferably, the bypass apertures provide uniform contamination loading of the non-qualifying layers of filter medium.

The majority of the prior art filters are small filters, which have to be replaced often due to clogging up by contaminants. For many filtration purposes these small filters are not suitable as large amounts of contaminated liquid are to be filtered.

Definitions

Bypass space. By a bypass space is to be understood an open space at the edges of layers of filtration medium and/or spacer medium through which open space contaminated liquid can circumvent part of the layers of filtration medium and/or spacer medium.

Central core. By a central core is to be understood a pipe or tube of a material with a high strength hereby maintaining the pipe-shape when in use. The material can be polymer or metal or the like. The central core is perforated with holes where liquid solution can pass through.

Contaminants. By contaminants is to be understood any particles, compounds or substances which is intended to be partly or fully separated from a liquid.

Contaminated liquid. By contaminated liquid is to be understood any liquid containing particles, compounds or any substances which is intended to be partly or fully separated from said liquid.

Deposition of contaminants. By deposition of contaminants is to be understood any way any contaminants can be caught and/or absorbed within the filtration medium or spacer medium or on the surface of the filtration medium or spacer medium.

End cap. By an end cap is to be understood a closure, which partly or fully closes layers of edges and/or ends of filtration medium and spacer medium. A cylindrical filter has one or two end caps, and a squared filter has from one to four end caps.

Filtration area. By a filtration area is to be understood the large surface of a filtration medium.

Filtration medium. By a filtration medium is to be understood a medium wherein a liquid or fluid containing particles and/or compounds can be filtered by absorbing and/or adsorbing at least part of the particles and/or compounds of the fluid and letting the fluid pass through the filtration medium. The filtration medium can be of different material.

Horizontal flow. By horizontal flow is to be understood a flow in the direction parallel to the pipe of the central core.

Inner layer. By an inner layer of filtration medium and an inner layer of spacer medium is to be understood layers of the mentioned media situated in the filter closest to where liquid that has been freed from contaminants exits the filter.

Layer. By a layer is to be understood a single sheet when the filter is composed of filtration medium and spacer medium which is stacked; when the filter is rolled a layer is one round of filtration medium and/or spacer medium.

Outer layer. By an outer layer of filtration medium and an outer layer of spacer medium is to be understood layers of the mentioned media situated in the filter closest to where contaminated liquid enters the filter.

Pores. By pores of filtration medium and spacer medium is to be understood any open structure of said media and where liquid can pass through. Depending on the pore size, part or none of particles and compounds in the liquid can pass through said media. The pores of the filtration medium and spacer medium need not be systematic ordered within said media. Natural and processed open structures of e.g. wool, cotton, and rock wool, hydrophobic cellulose etc. are also to be understood as pores.

Radial flow. By radial flow is to be understood a flow in the direction radially to the direction of the pipe of the central core.

Sealing. By a sealing is to be understood sealing or closing of one or more of layers of edges and/or ends of filtration medium and spacer medium. A sealing does not necessary need to seal the entire edge of one layer of filtration medium together with the entire edge of one layer of spacer medium next to said filtration medium. The sealing can partly seal the edge of one or more layers of filtration medium and/or spacer medium and partly seal the edge of spacer medium and/or spacer medium next to it. A sealing can be glue, or a sealing can be material attached by glue, or a sealing can be attached to the edge of layers of filtration medium and/or spacer medium due to the pressure of the end cap e.g. a packing ring fastened by the end cap. A sealing can also be a means that is forced into or in between the edge(s) of layers of filtration medium and/or spacer medium.

Spacer medium. By a spacer medium is to be understood a medium wherein a liquid or fluid containing particles and/or compounds can run. The spacer medium comprises more or less open areas between filtration media, and enhances the distribution of the contaminated liquid within the filter. The spacer medium can also be a filtration medium in the way that the spacer medium can function as a filtration medium by adsorbing or absorbing contaminants. The pores of the spacer medium is larger than the pores of the filtration medium.

### SUMMARY OF INVENTION

The present invention relates to a filter with layers of filtration medium optionally also with layers of spacer medium and bypass spaces at the edges of the layers of filtration medium and of the spacer medium if any. The invention also relates to a method of making a filter and a method of filtering a contaminated fluid. Due to the construction of the filter the filters can be of large dimensions, securing use up of the filtration medium rather than clogging of the filtration medium.

In a first aspect the present invention relates to a filter for liquid filtration, said filter comprises
at least two layers of filtration medium, comprising
   at least one inner layer of filtration medium and
   at least one outer layer of filtration medium,
   wherein each layer has at least one edge and a filtering area, and
wherein a first sealing is positioned outside of said at least one inner layer of filtration medium and inside of said at least one outer layer of filtration medium and said first sealing directs liquid to be filtered through the filtering area of said at least one inner layer of filtration medium, and wherein
the liquid to be filtered enters the layers of filtration material
   through the filtering area of said at least one outer layer of filtration medium and/or
   through said edge of said at least one outer layer of filtration medium and/or
   between two adjacent edges of layers of filtration medium.

Filters according to the present invention have been found to provide improved fluid distribution over the filtration medium resulting in an optimal use of the filtration medium, reduced pressure drop and increased filter life, without a reduction in filter rating.

Due to the filter composition of the present invention large filters can be produced wherein the filtration capability is high as the filtration medium is used up rather than clogged in outer layers. Clogging of outer layers inhibit contaminated fluid to enter the filter.

Preferred filters are produced of a plurality of layers of filtration medium and a plurality of layers of spacer medium arranged by turns. A method of producing the filter is to place at least one sheet of filtration medium and at least one sheet of spacer medium on each other and roll these around a core, in a way securing at least one layer of filtration medium closest to the core. The core has a plurality of apertures to make an exit of filtered liquid from the rolled filter. A closing mean e.g. glue or an end cap with sealings is placed on the edges of the rolled filter to secure closing of the edges of at least the one layer of filtration medium closest to the core.

Bypass spaces at the edges of the layers of filtration medium and spacer medium and an end cap with perforations covering the edges of the layers of the filtration and spacer medium ensure contaminated liquid can enter into the filter with a minimum of pressure drop through the lifetime of the filter. Predetermined volumes of bypass spaces and/or predetermined areas of perforations in the end cap and selection of the material of the filtration medium and spacer medium can be used to obtain a specific liquid flow through the filter in accordance with the accepted level of contaminants in the filtered liquid.

An end cap can be produced with a predetermined number of sealings, each sealing being more or less triangular, squared or trapeze-formed in a cross section and being more or less circular in the appearance when the end cap with the sealings are viewed from a distance. When the end cap is placed on the edges of the layers of filtration medium and spacer medium, the sealings are pressed onto or into the layers of filtration medium and/or spacer medium such as between 0.2 and 5 cm into the filter.

One or more exchangeable filter cartridges can be arranged in a filter house to produce a composite filter, securing an increased life-time of filters of a large size, by using filter cartridges of sizes ready to be handled by man.

The filters can be used by filling the filter house with contaminated liquid of a volume securing all edges of layers of filtration and spacer medium of the filter are covered by the contaminated liquid, although a filter only partly covered by contaminated liquid may function. Contaminated liquid enters the filter through the outermost layer of filtration and/or spacer medium by radial flow, or through the edges of filtration and/or spacer medium by a horizontal flow or it enters the filter by a horizontal flow between two layers of filtration medium, two layers of spacer medium or one layer of filtration medium and one layer of spacer medium.

### DESCRIPTION OF DRAWINGS

FIG. 1. Cross section of a cylindrical filter with layers of filtration medium and spacer medium and with indications of the position of sealings at the edges of the filtration medium and spacer medium. (1) Spacer medium, (2) Filtration medium, (3) Sealing, (4) Core.

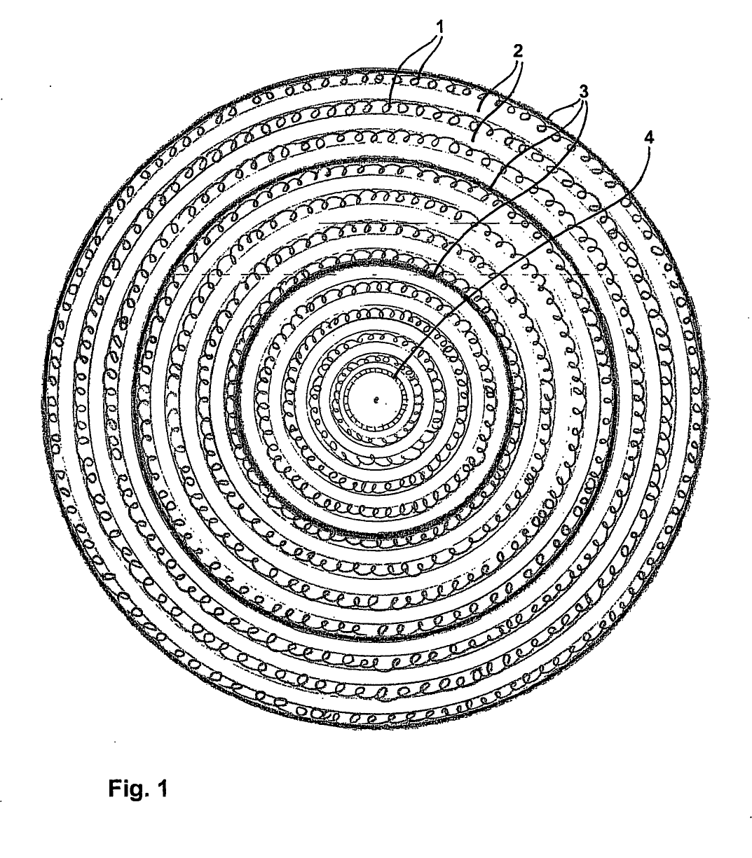

FIG. 2. Longitudinal section of a cylindrical filter with almost concentric rings of layers of filtration medium and spacer medium surrounding a core. The filter is constructed by rolling a layer of filtration medium and a layer of spacer medium around a core as further shown in FIG. 8. Sealings and perforations are shown at the end caps. The sealings are not gluing the edges of filtration medium and/or spacer medium. Only a small volume of bypass space is located between the edges of the layers of filtration medium and spacer medium and the inner side of the end cap. The bypass space can be a few mm or less or even absent in the sense that the edges of the filtration medium and spacer medium can bent a little an leave space for liquid to bypass. All layers within the inner sealings can also be only filtration medium. (1) Spacer medium, (2) Filtration medium, (3) Sealing, (4) Core, (5) End cap, (6) Perforations in end cap, (7) Apertures of core.

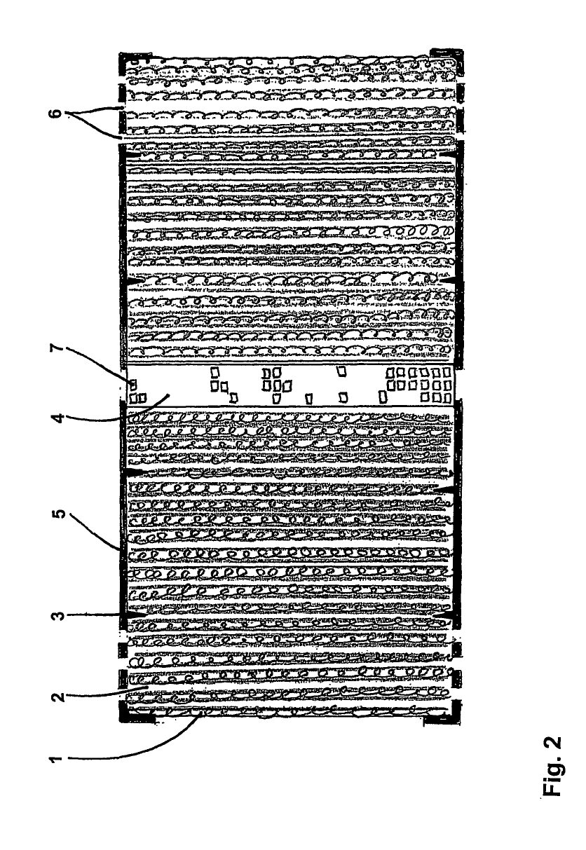

FIG. 3. Longitudinal section of a cylindrical filter showing the end cap with perforations, bypass space between the edges of layers of filtration/spacer medium and the end cap, and indication of some possible flow directions of the liquid to be filtered. (1) Spacer medium, (2) Filtration medium, (3) Sealing, (4) Core, (5) End cap, (6) Perforations in end cap, (7) Apertures of core, (8) Arrows indicating some possible flow directions of liquid to be filtered.

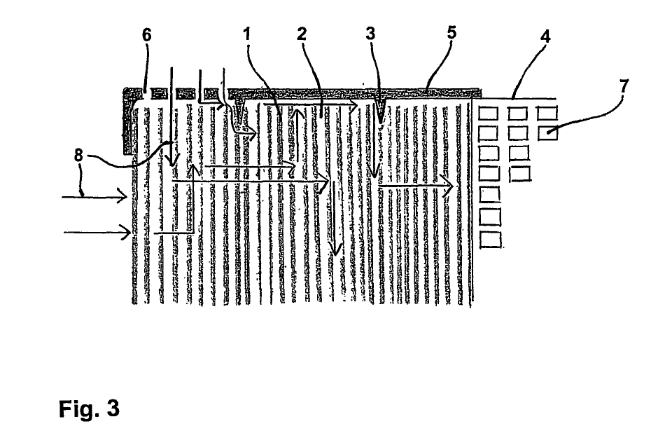

FIG. 4. An unrolled filtration medium from a cylindrical filter with bypass spaces in both ends of the filter, showing the deposit of the contaminants when the filter has been used for a relatively short time to filtrate contaminated liquid. The contaminants are deposited at and in the filtration medium close to the positions where the contaminated liquid enters the filter by passing through the bypass spaces. (2) Filtration medium, unrolled, (10) Deposits of contaminants.

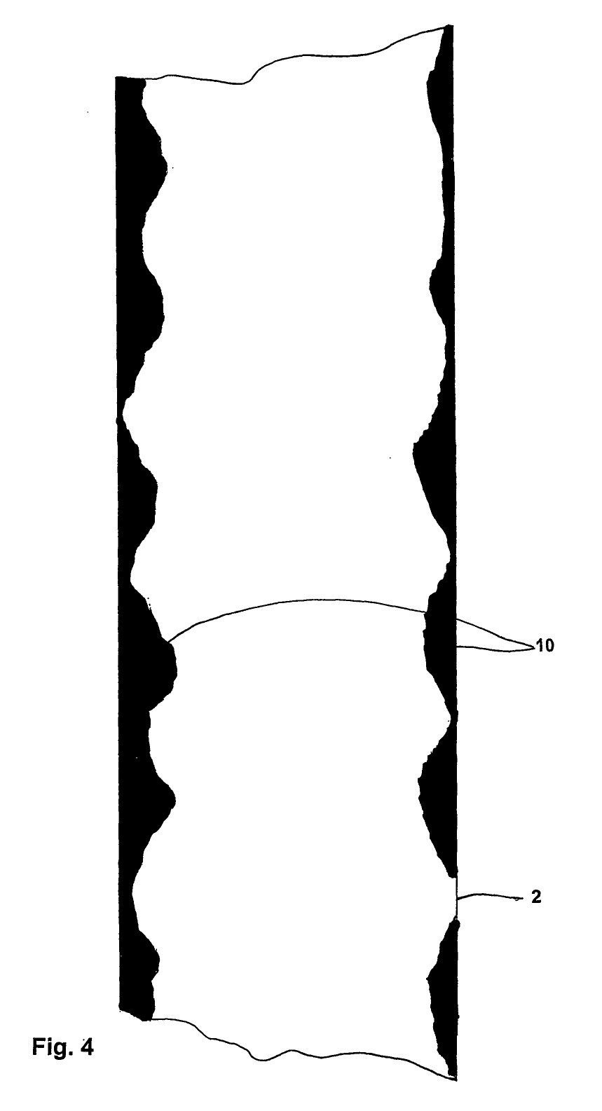

FIG. 5. An unrolled filtration medium from a cylindrical filter showing the deposit of the contaminants when the filter has been used for a longer time than the filtration medium of FIG. 4. Tongues of deposited material arise in the areas where the contaminated liquid enters the filter by passing through the bypass spaces. (2) Filtration medium, unrolled, (10) Deposits of contaminants.

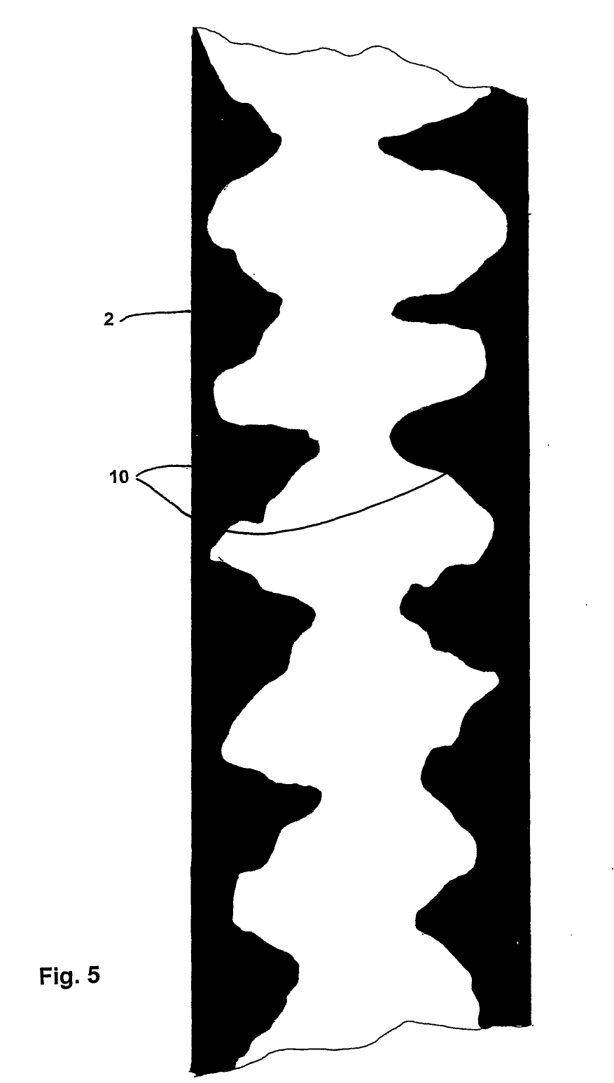

FIG. 6. An unrolled filtration medium from a cylindrical filter showing the deposit of the contaminants when the filter has been used for a longer time than the filtration material of FIG. 5. (2) Filtration medium, unrolled, (10) Deposits of contaminants.

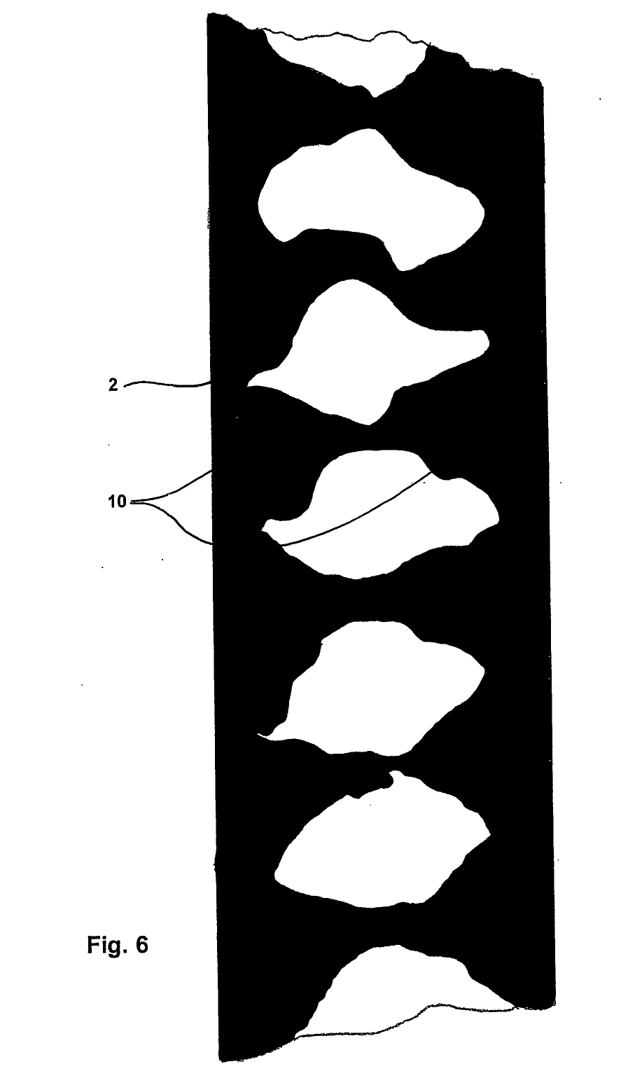

FIG. 7. A filter house with four filter cartridges. The composite filter is composed of filter cartridges of dimensions that can be handled by man. By including a plurality of filter cartridges in one filter house a long working time of the entire filter is ensured. (4) Core, (5) End cap, (11) Filter cartridge, (12) Inlet of contaminated liquid, (13) Sump for contaminated liquid to be filtered, (14) Outlet for filtered liquid.

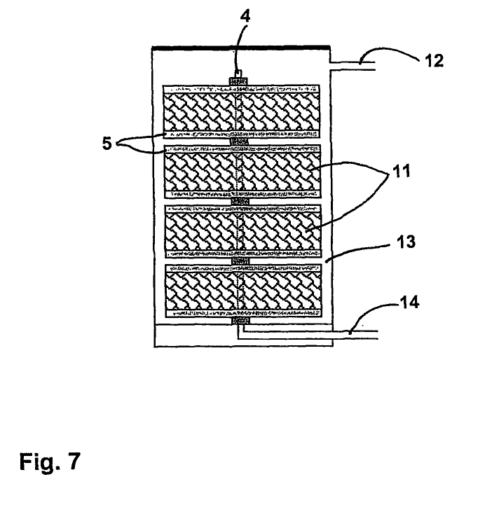

FIG. 8. Example of production of a rolled filter. Spacer medium is placed above filtration medium before rolled around a core. In the figure spacer medium and filtration medium is each shown with two different pore sizes. (1) Spacer medium, (2) Filtration medium, (4) Core.

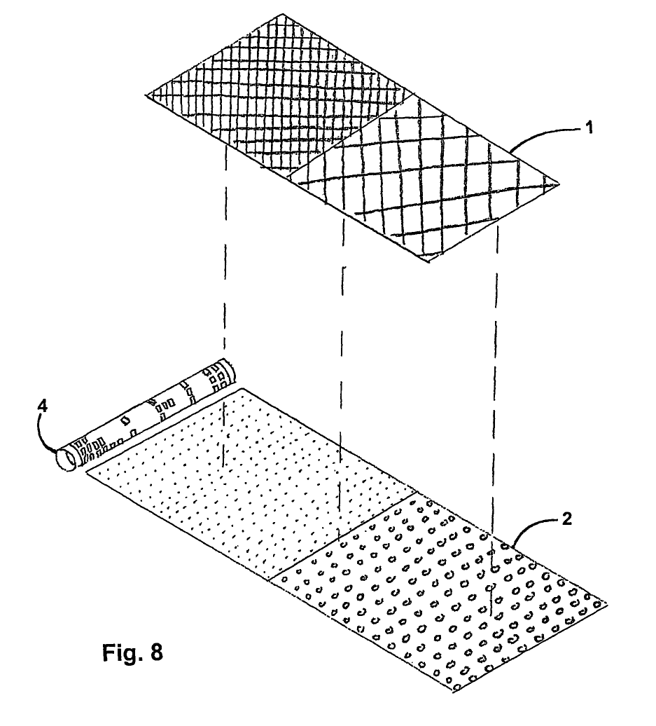

FIG. 9. Example of production of a rolled filter. Spacer medium is placed above filtration medium before rolled around a core. In the figure spacer medium is shown with three different pore sizes. (1) Spacer medium, (2) Filtration medium, (4) Core.

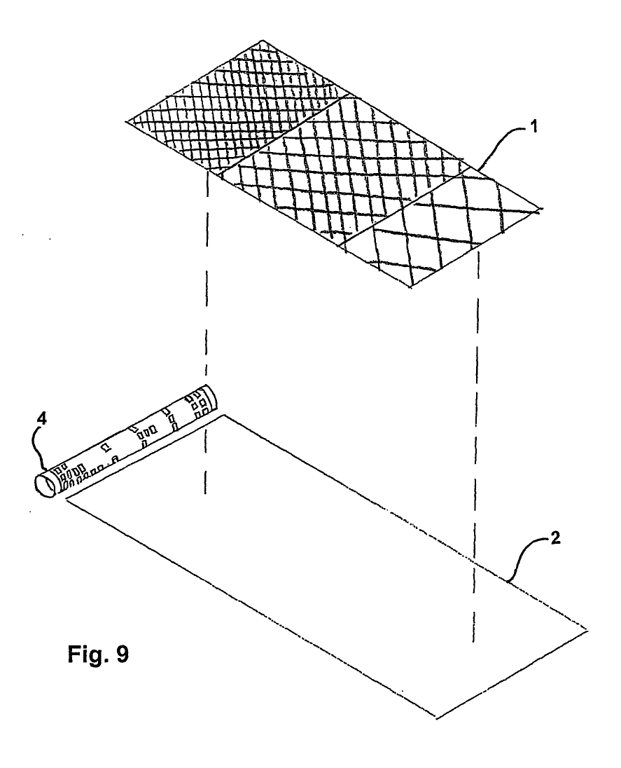

FIG. 10. Example of a method for making a filtration medium hydrophobic. (15) roll of filtration medium with non-treated cellulose fibre, (16) Bath with resin, (17) Waives for managing the sheet, (18) Waives releasing the filtration of the solution, (19) Bath with a solution of sulphate, (20) Oven, (21) Roll of filtration medium with hydrophobic filtration medium.

FIG. 11. Cross section of a rolled filter indicating the continuity of the layers of filtration madium and spacer medium. (1) Spacer medium, (2) Filtration medium, (3) Sealing, (4) Core.

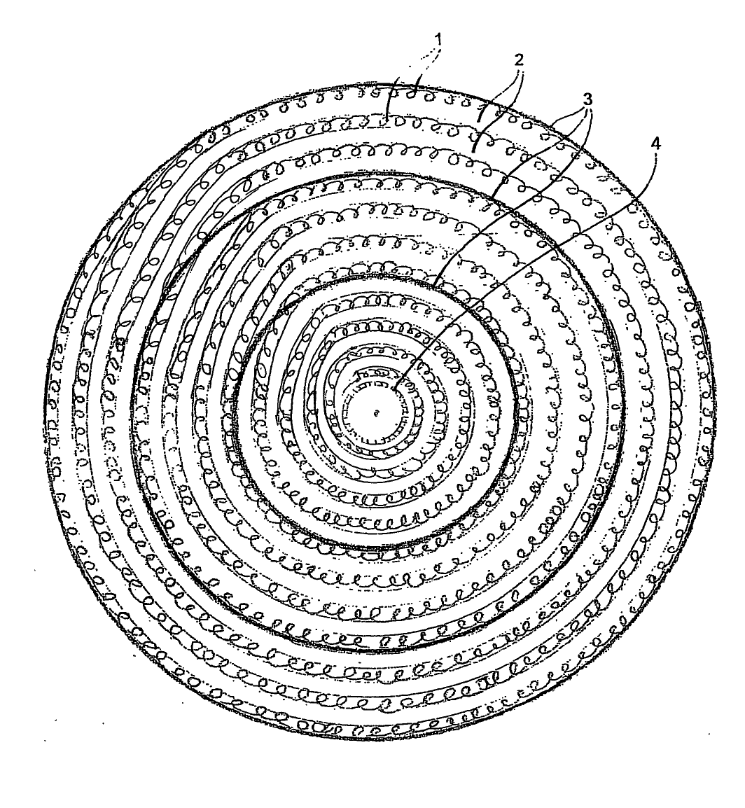

### DETAILED DESCRIPTION OF THE INVENTION

In a first aspect the present invention relates to a filter for liquid filtration, said filter comprises at least two layers of filtration medium, comprising at least one inner layer of filtration medium and at least one outer layer of filtration medium, wherein a first sealing is positioned outside of said at least one inner layer of filtration medium and inside of said at least one outer layer of filtration medium and said first sealing directs liquid to be filtered through the filtering area of said at least one inner layer of filtration medium, and wherein the liquid to be filtered enters the filtration material through the filtering area of said at least one outer layer of filtration medium and/or through said edge of said at least one outer layer of filtration medium and/or between two adjacent edges of layers of filtration medium.

In another aspect the present invention relates to a filter for liquid filtration, said filter comprises at least two layers of filtration medium, comprising at least one inner layer of filtration medium and at least one outer layer of filtration medium, wherein each layer has at least one edge and a filtering area, and wherein a first sealing seals said at least one edge of said at least one inner layer of filtration medium, and said first sealing directs liquid to be filtered through the filtering area of said at least one inner layer of filtration medium having the sealing, and wherein the liquid to be filtered enters the filtration material through the filtering area of said at least one outer layer of filtration medium and/or through said edge of said at least one outer layer of filtration medium and/or between two adjacent edges of layers of filtration medium.

Another aspect of the invention is a filter for liquid filtration, said filter comprises at least two layers of filtration medium, comprising at least one inner layer of filtration medium and at least one outer layer of filtration medium, wherein each layer has at least one edge and a filtering area, and wherein a first sealing seals said at least one edge of said at least one inner layer of filtration medium, and said first sealing directs liquid to be filtered through the filtering area of said at least one inner layer of filtration medium having the sealing, and wherein the liquid to be filtered enters the filtration material through the filtering area of said at least one outer layer of filtration medium and/or through said edge of said at least one outer layer of filtration medium and/or between two adjacent edges of layers of filtration medium.

In an embodiment the filter further comprising at least one layer of spacer medium, wherein the at least one layer of spacer medium has at least one edge and a spacer area, and wherein the at least one layer of spacer medium is provided between the at least on inner layer of filtration medium and the at least one outer layer of filtration medium with the spacer area of the spacer medium next to the filtration area of the filtration medium.

In a preferred embodiment the filter is composed of a plurality of alternating layers of filtration medium and spacer medium, and where contaminated liquid can bypass some of the layers of filtration medium and/or spacer medium and enter the filtration medium and/or spacer medium from the edges of the filtration medium and spacer medium.

The alternating composition of the filter relating to filtration medium and spacer medium together with bypass space and/or perforations in an end cap increases the capacity of the filter measured by amount of filtered liquid per time unit as well as increasing the filter life. The spacer medium disperses the contaminated liquid throughout the layers of filtration medium. Hereby the filtration medium is not clogged by contaminants as in a filter without a spacer medium. Allowing contaminated liquid to bypass layers of filtration medium and spacer medium further increases the capacity of the filter, filtration rate and the filter life. When the contaminated liquid bypass layers of filtration medium and spacer medium the contaminants are dispersed more evenly throughout the filtration layers of the filter.

Clogging up of filter cartridge limits the possibility to produce large filters. As layers of filtration medium trap the contaminants in the contaminated liquid, the filter eventually clogs up, the pressure of the filtered liquid drops and with time contaminated liquid cannot enter the filter. In a clogged up filter cartridge all filtration medium is seldom utilized for filtration, that is, contaminants are not deposited within all filtration medium. In a filter composed only of filtration medium, the filter has to be replaced when 2-10% of the outer filtration medium has trapped up contaminants.

The construction of a filter according to the present invention increases the filter capacity and filter life by distributing the contaminated liquid or especially the contaminants of the contaminated liquid to a larger area of the filtration medium. The filter only needs to be replaced when 50-90% of the filtration medium has trapped up contaminants, depending on the construction of the filter. This is a surprisingly high filtration capacity obtained by the present invention.

It is not necessary a goal to obtain an even distribution of contaminated liquid within the filter, rather filter with increased filter capacity and increased filter life time is obtained.

The filters of to the present invention may be inexpensive due to a simple construction.

In another aspect the present invention relates to a filter for liquid filtration, said filter comprises
at least one inner layer of a filtration medium and
at least one outer layer of a filtration medium and/or spacer medium,
wherein said layers of filtration medium and/or spacer medium each has at least one edge not fully in contact with the other layers of filtration medium and/or spacer medium,
wherein an end cap with at least one sealing is placed on the edges of said filtration medium and/or spacer medium, leaving bypass space between said end cap and the edges of filtration medium and/or spacer medium, and
wherein said at least one sealing direct liquid to be filtered into the filter through the edges of the filtration medium and/or spacer medium and/or into the filter between two adjacent layers of filtration medium and/or spacer medium.
   Sealings and Bypass Spaces

Sealings are used to close and/or seal edges of one or more layers of filtration medium and spacer medium, and/or to force liquid to enter the filtration medium

The part of the filter where filtrated liquid exits the filtration medium is denoted the inner part of the filter. In one embodiment of the invention a first sealing seals at least the innermost layer of filtration medium in the inner part of the filter. This first sealing prohibit liquid to enter said at least one edge of said sealed at least one inner layer of filtration medium. The sealing can encapsulate the edge of the at least one inner layer of filtration medium. The first sealing can also be a glue joint prohibiting liquid to enter said at least one edge of said glued at least one inner layer of filtration medium.

In another embodiment the filter further comprising a second sealing, said second sealing seals one or more of said edges of layers of filtration medium and/or spacer medium, wherein said first sealing and said second sealing have a mutual distance, and where the edges of filtration medium and/or spacer medium between said first sealing and said second sealing are unsealed.

The sealings of the embodiments need not seals the edge of layers of filtration medium and/or spacer medium. The sealings can direct the liquid to be filtered into the filtration medium and/or spacer medium as described elsewhere herein.

In yet another embodiment the filter further comprises a number of additional sealings with distance to said second sealing and each with mutual distance, and wherein said additional sealing each is sealing one or more of the edges of said layers of filtration medium and/or of the edges of said spacer medium or the sealing is pressed in between layers of filtration medium and/or spacer medium. The edges of the filtration medium and the spacer medium between each sealing are unsealed.

In a further embodiment of the filter said second sealing and/or said additional sealings each comprises sealing said edges of filtration medium and/or spacer medium and wherein said sealing comprises encapsulation of one or more of said edges of layers of filtration medium and/or spacer medium or gluing one or more of said edges of layers of filtration medium and/or spacer medium.

In a preferred embodiment the sealings are pressed in between layers of filtration medium and/or spacer medium in a way not encapsulating or gluing edges of layers of filtration medium and/or spacer medium. When the sealings are pressed in between layers of filtration medium and/or spacer medium, the edges of the filtration medium and/or spacer medium may be bent or pressed aside.

The sealing can be an integrated part of an end cap where said end cap also provides open spaces comprising bypass spaces between said sealings. Contaminated liquid or filtered liquid can enter said bypass spaces and further enter into said filtration medium through said edges of said filtration medium and said spacer medium or between two adjacent edges of layers of filtration medium and/or layers of spacer medium.

Sealings can also be used to mount the end cap, which is described below, to the edges of layers of filtration medium and spacer medium. A filter may have at least one end cap comprising a first sealing, which comprises totally closing, sealing or encapsulation of the end of at least one of the inner layers of filtration medium or is a barrier to liquid to be filtered, forcing said liquid into filtration medium or spacer medium.

It is of outermost importance that contaminated liquid cannot pass through the filter without passing through at least one layer of filtration medium. To ensure this filtration of contaminated liquid the innermost part of edges of at least one layer of filtration medium may be sealed or a number of layers of filtration medium have a sealing at the outside of one of the outer layers of these layers of filtration medium. In this case the innermost layers of filtration medium need not be sealed by glue or the like.

In an embodiment the first sealing comprises totally closing of the edges of at least one of the inner layers of filtration medium together with the edge of at least one of the inner layers of spacer medium, wherein said at least one of the inner layers of filtration medium and said at least one of the inner layers of spacer medium are situated next to each other.

The sealings described herein can have the only function to seal the edges of the at least one layer of filtration medium or to seal the edges of the at least one layer of filtration medium together with the intermediate spacer medium. The sealing can further have the function to attaching the end cap to the filtration medium and spacer medium.

When sealings are described herein to seal edges of layers of filtration medium and/or spacer medium this can be substituted with sealings that do not have a gluing function, but each is a barrier to the liquid to be filtered, forcing said liquid to enter into filtration medium and/or spacer medium in ways described elsewhere herein.

When the sealings seal part of the area between an end cap and the edges of filtration medium and spacer medium, open area are obtained between the end cap and the edges of filtration medium and spacer medium, these open areas are bypass spaces. The function of a sealing is to force the contaminated liquid to enter into the layers of filtration medium and/or spacer medium. After the contaminated liquid are forced by a sealing to enter into filtration medium and/or spacer medium, the liquid can stay within the filtration medium and/or spacer medium within the rest of the filter cartridge or less contaminated liquid can exit the filtration medium and/or spacer medium on the other side of the sealing hereby entering another bypass space, and the liquid can again enter into the filtration medium and/or spacer medium at the next sealing. Eventually the liquid without contaminants pass through the innermost layer(s) of filtration medium and exits the filter through a core as described herein below.

The number of innermost layers of filtration medium and spacer medium sealed in the edges may change due to filter size or which kind of contaminated liquid is to be filtered. In an embodiment at least one of the inner layers of filtration medium and/or at least one of the inner layers of spacer medium that are sealed at the edges or are located inside of a sealing are at least 2 layers of filtration and/or spacer medium, such as at least 3 layers, such as at least 4 layers, such as at least 5 layers, such as at least 6 layers, such as at least 7 layers, such as at least 8 layers, such as at least 9 layers, such as at least 10 layers. Preferred is sealing of at about 1-7 layers. More preferred is sealing of about 5 layers.

In a preferred embodiment at least 2 layers of filtration medium are located inside of a sealing, said sealing gluing or not gluing the edges of the filtration medium. The number of filtration medium may also be at least 3 layers, such as at least 4 layers, such as at least 5 layers, such as at least 6 layers, such as at least 7 layers, such as at least 8 layers, such as at least 9 layers, such as at least 10 layers, such as at least 11 layers, such as at least 12 layers, such as at least 13 layers, such as at least 14 layers, such as at least 15 layers, such as at least 16 layers, such as at least 17 layers, such as at least 18 layers, such as at least 19 layers, such as at least 20 layers, such as at least 25 layers.

In an embodiment the filter comprises at least one end cap comprising a second sealing, said second sealing comprises totally closing of the space between the edge of a number of layers of filtration medium and/or spacer medium and said end cap, wherein the first sealing and the second sealing leaves a bypass space for contaminated liquid between said end cap and the edges of the layers of filtration medium and spacer medium positioned between the first sealing and second sealing.

In another embodiment the filter comprises a number of additional sealings that are situated outside of the second sealing, and wherein said additional sealings each are sealing said end cap to the edge of said layers of filtration medium and of said spacer medium and leaving bypass space between the end cap and the edges of the layers of filtration medium and spacer medium.

In yet another embodiment said number of additional sealings are at least 1, such as at least 2, for instance at least 3, such as at least 4, for instance at least 5, and each additional sealing increases the number of bypass spaces. Preferred is 1 or 2 additional sealings in excess of first sealing.

The sealings need not be distributed evenly across the filter, the space between two sealings may be from about 0.4 to 20 cM, such as from about 0.5 to 15 cM, e.g. about 1 to 10 cM, such as from about 1.5 to 8 cM, e.g. about 2 to 7 cM, such as from about 3 to 6 cM, e.g. about 4 to 5 cM. Preferred is when the sealings are distributed with about 5 cM.

The second sealing and/or said additional sealings each comprises sealing of part of edges of filtration medium and part of edges of spacer medium. In this way it is not important that the entire edge of a single or more edges of filtration medium and spacer medium are sealed. The sealing may fluctuate between the edges of the layers of filtration medium and spacer medium.

Each sealing may have a width of about 0.1 to 15 cM, such as about 0.15 to 1 cM, e.g. about 1 to 3 cM, such as about 3 to 5 cM, e.g. about 5 to 7 cM, such as about 7 to 9 cM, e.g. about 9 to 11 cM, such as about 11 to 13 cM, e.g. about 13 to 15 cM. Preferred is a width of about 0.1 to 3 cM. More preferred is a width of about 0.2 to 2 cM. Most preferred is a width of about 0.1 to 0.5 cM.

The sealings can have any length from the inner side of the end cap to the end pointing towards and/or in between the edges of the layers of filtration medium and spacer medium.

In one embodiment the length of the sealing is between 0.1 and 15 cM, such as about 0.1 to 1 cM, e.g. about 1 to 2 cM, such about 2 to 3 cM, e.g. about 3 to 4 cM, such about 4 to 5 cM, e.g. about 5 to 6 cM, such about 6 to 7 cM, e.g. about 7 to 8 cM, such about 8 to 9 cM, e.g. about 9 to 10 cM, such about 10 to 11 cM, e.g. about 11 to 12 cM, such about 12 to 13 cM, e.g. about 13 to 14 cM, such about 14 to 15 cM. Preferred is a length of the sealings of about 0.1 to 5 cM. More preferred is a length of the sealings of about 0.2 to 3 cM. Most preferred is a length of the sealings of about 0.3 to 2 cM.

The sealings can have any suitable form when observed in a cross section. The form of the cross section may be e.g. squared, triangular, round, trapeze or anything in between. Preferred are triangular or trapeze sealings. More preferred are trapeze sealings. The height and width of said trapeze sealings can be as described elsewhere herein, where the width is the width at the base of the trapeze sealing, and the width at the top of the trapeze sealing is lesser than the width at the base. In one embodiment the width at the top of the trapeze sealing is smaller than the width at the base, such as 5-10% smaller, e.g. 10-15% smaller, such as 15-20% smaller, e.g. 20-25% smaller, such as 25-30% smaller, e.g. 30-35% smaller, such as 35-40% smaller, e.g. 40-45% smaller, such as 45-50% smaller, e.g. 50-55% smaller, such as 55-60% smaller, e.g. 60-65% smaller, such as 65-70% smaller, e.g. 70-75% smaller, such as 75-80% smaller, e.g. 80-85% smaller, such as 85-90% smaller, e.g. 90-95% smaller. Preferred is 25-95% smaller. More preferred is 40-80% smaller. Most preferred is 50-70% smaller.

The sealings can be constructed of any suitable material. In an embodiment the sealing comprises hydraulic glue, polymer, rubber packing, and metallic packing. The sealings can also comprise polyethylene, polypropylene, polyolefins, polyamids. Preferred is when the sealings comprise polyethylene or polypropylene.

The sealings can be separate of the end caps, which is described below. The sealings can also be mounted on the end caps, or sealings and end cap can be cast in one piece depending of the material of the end cap.

The function of the bypass spaces is to enhance the entry of contaminated liquid into the filter. Enhancing the entry means the flow rate is improved respectively to the deposition of contaminants within the filter and when comparing to filter without bypass spaces, as more contaminated liquid can enter the filter than in a filter without the bypass spaces. Enhancing the entry also means that as the filter has been used for a time and contaminants are deposited within the filter, the contaminated liquid still has enhanced possibility to enter into the filtration medium and spacer medium.

The bypass spaces can have different dimensions depending on the filter construction, the configuration of the end cap with or without perforations as described elsewhere herein, and the type of contaminated liquid to be filtered. The bypass spaces can be absent in the meaning that the end cap is placed in contact with at least some edges of the layers of filtration medium and/or spacer medium, but without gluing the end cap to the edges of the layers of filtration medium and/or spacer medium a small volume for liquid to by pass layers of filtration medium and/or spacer medium is present. The bypass space may be at least 0.1 cm, such as at least 0.2 cm, such as at least 0.3 cm, such as at least 0.4 cm, such as at least 0.5 cm, such as at least 0.6 cm, such as at least 0.7 cm, such as at least 0.8 cm, such as at least 0.9 cm, such as at least 1.0 cm, such as at least 1.5 cm.

The bypass spaces improves the filter life, the filtration rate and ensure no or only a little pressure drop as the filter is in function. The bypass spaces further optimise the possibility to construct large filters wherein the filtration medium is used up with no or only a little pressure drop across the filter cartridge is obtained as the filter is about to be replaced with a new filter.

By a large filter is to be understood a filter where the thickness of the layers of filtration medium and spacer medium substantially comprising the radius of the filter is above 4 cM, such as above 6 cM, e.g. above 8 cM, such as above 10 cM, e.g. above 15 cM, such as above 20 cM, e.g. above 25 cM, such as above 30 cM, e.g. above 35 cM, such as above 40 cM, e.g. above 45 cM.

In another embodiment the radius of the filter comprises 1-5 cM, such as 5-10 cM, such as 10-15 cM, such as 15-20 cM, such as 20-25 cM, such as 25-30 cM, such as 30-35 cM, such as 35-40 cM, such as 40-45 cM, such as 45-50 cM, such as 50-60 cM, such as 60-70 cM, such as 70-80 cM, such as 80-90 cM, such as 90-100 cM. Preferred is a radius of between 5 and 80 cM. More preferred is a radius of between 15 and 60 cM. Preferred is a radius of between 30 and 40 cM.

End Cap

Sealings not connected to an end cap (thus no end cap at all) or at least one end cap may be utilised at the edges of layers of filtration medium and spacer medium.

The end cap of the present invention has several functions. It supports the structure of the layers of filtration medium and spacer medium, hereby keeping the filter together. It provides bypass space where more or less contaminated liquid can circumvent part of the filter. It provides holding means when the filter is placed in, or removed from a filter house as described herein below.

An end cap can be self-adhesive sealings only, where the sealings are used to seal the edges of layers of filtration medium and spacer medium as described above.

The end cap can also be a unit, which is placed on, and sealed to the edges of filtration medium and spacer medium.

In an embodiment the end cap comprises perforations in the end cap itself in the area outside of the first sealing, and contaminated liquid can run through said perforations. Hereby the amount of liquid that can be filtered per time unit is increased, as the barrier for the contaminated liquid to enter the filter is lowered.

The combination of perforations in the end cap and sealings between the end cap and the edges of filtration medium and spacer medium, has been found to have a synergistic effect of simultaneously increasing filtration capacity and minimizing pressure drop across the filter cartridge without reducing the filter rating.

The perforations of the end cap can be of any size from 0.0005 cM² to at least 100 cM², depending on the stability of the material utilized to produce the end cap. The perforations can be of sizes between 0.0005-0.5 cM², 0.5-1 cM², 1-2 cM², 2-3 cM², 3-4 cM², 4-5 cM², 5-7 cM², 7-10 cM², 10-20 cM², 20-40 cM², 40-60 cM², 60-80 cM², 80-100 cM². Preferred are perforations of 0.005 cM² to 10 cM². More preferred are perforations of 0.05 cM² to 5 cM². Most preferred are perforations of 0.1 cM² to 1 cM².

The end cap can be produced of any water stabile material such as metal or polymers. Preferred materials are polymers, more preferred are polyethylene and polypropylene. If the liquid to be filtered is water-free other materials may also be used to produce the end cap.

The thickness of end caps in the areas outside of the sealings can be between substantially 0.01 to 1.5 cm, such as between 0.1 to 1.2 cm, e.g. 0.2 to 1.0 cm, such as 0.3 to 0.8 cm, e.g. 0.4 to 0.6 cm. Preferred is thickness of 0.1-0.7 cm. More preferred is 0.2-0.5 cm. Most preferred is substantially 0.3 cm.

The shape of the end cap can be adapted to the form of the filter. When the filter is composed of stacked layers of filtration medium and spacer medium, the preferred shape of the end cap is quadrangular. To a filter of stacked layers, the number of end cap is from one to six, where one to all of these end caps can have perforations as described herein above.

When the filter is cylindrical as described below, the preferred shape of the end cap is circular. The preferred number of end cap for a cylindrical filter is two, although one end cap can be enough. Depending of the field of application, the filter is constructed with end caps with small or larger perforations, if any perforations at all. In general, increasing the numbers and/or size of perforations increases the flow rate through the filter.

Independent of the overall shape of the end cap, the end cap can be substantially flat or more or less v-shaped in a side view. The v-shaped end cap lets a larger amount of contaminated liquid enter into the filter. Preferred is when then end cap is substantially flat.

The size of the end cap can be selected from smaller than the dimension of the filter to cover, to larger than the dimension of the filter. Preferred is when the end cap has dimension that substantially fit to the dimension of the filter.

The end cap can have one or more apertures to fit to the cores as described herein below. Preferred is when the aperture is centrally placed in the end cap and fit to a central core of a cylindrical filter. No contaminated liquid can enter into the apertures, as these are to drain filtered liquid through cores mounted in the apertures of the end cap.

The end caps of a box-like filter can be clasped or fastened by a fastening mean around a stack of layers of filtration medium and spacer medium. Preferred is when the end caps are placed at the four edges perpendicular to the layers of filtration medium and spacer medium.

Filtration Medium and Spacer Medium

The filtration medium can be any medium that can separate contaminants from a contaminated liquid. Spacer medium can be any medium that can perform any kind of space between two layers of filtration medium. The spacer medium may also have a separating effect upon the contaminated liquid and hereby separate part of the contaminants from the contaminated liquid.

In an embodiment said filtration medium and said spacer medium have pores and the pores of the spacer medium are larger than the pores of the filtration medium.

The pores of the filtration medium is larger than 0.5 μM, such as larger than 2 μM, e.g. larger than 5 μM, such as larger than 10 μM, such as larger than 20 μM, such as larger than 30 μM, such as larger than 40 μM, such as larger than 50 μM, such as larger than 60 μM, such as larger than 70 μM, such as larger than 800 μM, such as larger than 90 μM, such as larger than 100 μM, such as larger than 110 μM, such as larger than 120 μM, such as larger than 130 μM, such as larger than 140 μM, such as larger than 150 μM, such as larger than 160 μM.

In another embodiment the pores of the filtration medium is comprises an average dimension of 0.5-5 μM, such as 5-10 μM, e.g. 10-20 μM, such as 20-30 μM, such as 30-40 μM, such as 40-50 μM, such as 50-60 μM, such as 60-70 μM, such as 70-80 μM, such as 80-90 μM, such as 90-100 μM, such as 100-110 μM, such as 110-120 μM, such as 120-130 μM, such as 130-140 μM, such as 140-150 μM. Preferred is 5-70 μM. More preferred is 10-40 μM. Most preferred is 20-60 μM.

The pores of the spacer medium can be larger than 0.05 μM, such as larger than 0.1 cM, e.g. larger than 0.2 cM such as larger than 0.4 cM, e.g. larger than 0.6 cM, such as larger than 0.8 cM, e.g. larger than 1.0 cM, such as larger than 1.5 cM, e.g. larger than 2.0 cM, such as larger than 2.5 cM, e.g. larger than 3.0 cM, such as larger than 3.5 cM, e.g. larger than 4.0 cM, such as larger than 4.5 cM, e.g. larger than 5.0 cM. Preferred are pores of 0.05-3 cM. More preferred are pores of 0.1-2.5 cM. Most preferred are pores of 0.2-2 cM.

The pores of the spacer medium are larger than the pores of the filtration medium. The ratio of the size of pores of the spacer medium to the size of pores of the filtration medium is between 1,1 and 25, such as between 25 and 50, e.g. between 50 and 75, such as between 75 and 100, e.g. between 100 and 125, such as between 125 and 150, e.g. between 150 and 175, such as between 175 and 200, e.g. between 200 and 225, such as between 225 and 250, e.g. between 250 and 275, such as between 275 and 300, e.g. between 300 and 325, such as between 325 and 350, e.g. between 350 and 375, such as between 375 and 400, e.g. between 400 and 450, e.g. between 450 and 500. Preferred is a ratio between 175 and 225. More preferred is a ratio between 200 and 225. Most preferred is a ratio of about 200.

The ratio of the size of pores of the spacer medium to the size of pores of the filtration medium may also be at least 500, such as at least 750, such as at least 1000, such as at least 1250, such as at least 1500, such as at least 1750, such as at least 2000, such as at least 2250, such as at least 2500, such as at least 2750, such as at least 3000, such as at least 3250, such as at least 3500, such as at least 3750, such as at least 4000, such as at least 4500, such as at least 5000.

In an embodiment said pores of said filtration medium and of said spacer medium constitute a porosity, and said porosity is substantially uniform throughout the filter. The porosity has a variation within a smaller area of the filtration medium and spacer medium, and by a porosity which is substantially uniform throughout the filter is meant that the variation within smaller areas are substantially uniform throughout the filter.

In another embodiment said pores of said filtration medium and said spacer medium constitute a porosity, and said porosity varies through the filter. In a stacked filter layers of filtration medium or spacer medium of different porosity is used. In a cylindrical filter the filtration medium and/or spacer medium where said porosity varies through the filter comprises different sections of filtration medium and/or spacer medium. The filtration medium and/or spacer medium can also be constructed with different porosity in different areas of the medium that is wrapped around a core.

In an embodiment said porosity of the filtration medium and/or spacer medium varies through the filter due to graded pore structure. Preferred is when said pores are smaller in the inner layers of said filtration medium and/or said spacer medium.

Materials of Filtration Medium and Spacer Medium

The filtration medium can be produced by a product selected from the group of: Polymers, paper, plant fibres, peat, plastics, wool, cotton, rock wool, cellulose, coal fibre and/or glass wool. Preferred is when the filtration medium is produced by a product selected from the group of polymers, plant fibres, wool, cotton, cellulose, and/or activated coal fibre. More preferred is when the filtration medium is produced of polymers selected from the group of polypropylene, polyethylene, polyester, and/or polycarbonat.

In the construction of filtration medium with plant fibre, preferred is plant fibre selected from plants of the group of flax, elephant grass, hemp, hop, cotton, coconut palm, trees, straw, hay.

In an embodiment the filtration medium is produced by sheets of any or a combination of the above mentioned materials, preferred is when the sheets are produced mainly of cellulose fibres and/or polymer fibres. More preferred is when the filtration medium is produced of 90-95% of cellulose fibre. Most preferred is when the filtration medium is produced of polymer fibres. Sheets of 100% melt-blown low-density polymer fibres are preferred for filtration medium.

Polymer Fibres

The filtration medium may be substantially composed of polymeric material, particularly solid or semi-solid polymers. Polymers are the family of synthetic or natural macromolecules consisting of inorganic, organic polymers and combinations thereof. Organic polymers may be natural, synthetic, copolymers, or semisynthetic polymers. Natural polymers comprise of the class of compounds known as polysaccharides, polypeptides, and hydrocarbons such as rubber and polyisoprene. Synthetic polymers comprise elastomers such as nylon, polyvinyl resin, polyvinyl chloride, polyvinyl dichloride, polyvinylpyrrolidone, polyethylene, polystyrene, polypropylene, polyurethane, fluorocarbon resins, acrylate resins, polyacrylates, polymethylmethacrylate, linear and cross-linked polyethylene, phenolics, polyesters, polyethers, polypyrolidone, polysulfone, polyterpene resin, polytetrafluoroethylene, polythiadiazole, polyvinylalcohol, polyvinylacetal, polyvinyl oxides, and alkyds. Semisynthetic polymers may be selected from cellulosics such as rayon, methylcellulose, cellulose acetate and modified starches. Polymers may be atactic, stereospecific, stereoregular or stereoblock, linear, cross-linked, block, graft, ladder, high, and/or syndiotactic.

Preferred polymeric materials are however presently believed to be those selected from the group comprising polyolefins, such as polyethylene, polypropylene, polybutene, polyisoprene, and polyvinylpyrrolidone, combinations thereof, particularly polyethylene and polypropylene, most particularly polypropylene.

In an embodiment the polymer materials of the filtration medium and/or spacer medium may be from the group of polyethylenes or the group of polypropylenes such as polyethylene (PE), polypropylene (PP), high molecular weight polypropylene (HMWPP), high molecular weight polyethylene (HMWPE), ultra high molecular weight polyethylene (UHMWPE) and ultra high molecular weight polypropylene (UHMWPP), high density polyethylene (HDPE), low density polyethylene (LDPE), high density polypropylene (HDPP) and low density polypropylene (LDPP), ultra high density polyethylene (UHDPE), ultra high density polypropylene (UHDPP), cross-linked polyethylene, non-cross-linked polyethylene, cross-linked polypropylene, and non-cross-linked polypropylene.

In an embodiment of the present invention, any combination of polymers listed above, or their equivalents, may be used.

Preferred are fibres of any of the mentioned polymers of low density.

In one embodiment the fibres are melt blown low density polymer.

Cellulose Fibres

One preferred material in the construction of the filtration material is cellulose fibre. These cellulose fibre can be natural or may be altered. Preferred is when said cellulose fibres are hydrophobic.

The sheets of cellulose fibres are non-woven or woven sheets, preferred is non-woven sheets of cellulose fibres and/or non-woven sheets of polymer fibre as well as woven sheets of cellulose fibres and/or woven sheets of polymer fibre.

The cellulose fibres are made hydrophobic by treatment with compounds selected from the group of wax, starch, natural resins, synthetic resins, water insoluble polyvinyl alcohol, hydroxyethyl cellulose, ethyl cellulose, carboxymethyl cellulose, polyacrylate resin, alkyd resin, polyester resin. Preferred is when said cellulose fibres are made hydrophobic by treatment with natural resins.

Resins for treatment of the cellulose fibre can be but are not limited to Mobilcer®, Tlim®, Silicex Silikonate®, Rhodorsil®, Panodan AB®, Aquapel®, Kymene®, Escorez®, Wacker Silicone®.

The cellulose fibres are made hydrophobic by a solution of about 1-70% hydrophobic emulsion of the compounds mentioned above, such as about 5-50%, e.g. about 10-40%, such as about 10-30%, e.g. about 15-25%, such as about 17-23%, e.g. about 20%. Preferred is about 20% of a natural resin.

The cellulose fibres are made hydrophobic by contacting the cellulose fibres with the mentioned hydrophobic emulsion for about 0.05-30 minutes, such as for about 0.1-20 minutes, e.g. about 0.2-15 minutes, such as about 0.3-10 minutes, such as about 0.4-7.5 minutes, e.g. about 0.5-5 minutes. Preferred is about 0.5-5 minutes

Preferred is when sheets of cellulose fibres are made hydrophobic by contacting with said hydrophobic emulsion for 0.3-10 minutes, more preferred is about 0.4-7.5 minutes, most preferred is about 0.5-5 minutes.

Following contact with the hydrophobic emulsion, the hydrophobic cellulose fibres or hydrophobic cellulose sheets contacted with the hydrophobic emulsion is released for water by dripping off or pressing water out of the cellulose. Preferred is when the water is pressed out of the cellulose fibre or cellulose sheets.

The hydrophobic cellulose fibres or sheets released for water is contacted with a solution of potassium sulphate or aluminium sulphate, or potassium-aluminium sulphate, in the concentration of about 0.01-30%, such as about 0.05-20%, e.g. about 0.1-10%, such as about 0.2-5%, e.g. about 0.54%, such as about 1-3%, e.g. about 2%. Preferred is about 0.54%, more preferred is about 1-3%, most preferred is about 2%.

The hydrophobic fibres or sheets contacted with potassium sulphate, sodium sulphate or potassium-aluminium sulphate is released for water and dried. The resin is melted on the surface of the cellulose fibre in a process where the cellulose fibre also is dried, this is either by ironing or oven treatment at a temperature of 60-150° C. Preferred is when the fibres or sheets are pressed dry and further dried in an oven at about 110° C. for about 20 minutes.

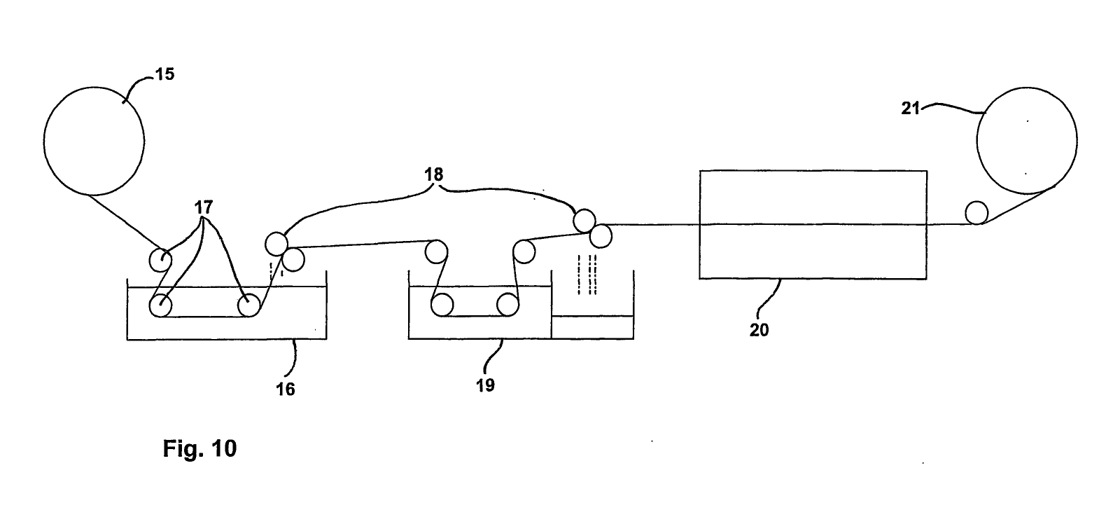

One process where the cellulose fibre are made hydrophobic is illustrated in FIG. 10 where a sheet of cellulose fibre from a roll of filtration medium (15), by use of valves (17) is directed to a bath with resin (16), released for fluid between two waives (18), further treated in a bath with a solution of potassium sulphate, sodium sulphate or potassium-aluminium sulphate (19), released for fluid (18), heat treated in an oven (20) and rolled on a roll comprising with hydrophobic filtration medium (21).

Materials of Spacer Medium

In an embodiment the spacer medium is produced by a product selected from the group of polymers, paper, plant fibres, plastics, wool, cotton, rock wool, cellulose, coal fibre, metal and/or glass wool. Preferred is when the spacer medium is produced by polymers. More preferred is when the spacer medium is produced by polymers selected from the group of polypropylene, polyethylene, polyester, polycarbonat. Polymers mentioned regarding filtration medium can also be used for spacer medium.

The structure of the spacer medium can be any structure where the strands of the material are systematically oriented to random orientation. Preferred is when the spacer medium includes a first plane of spaced apart parallel strands forming longitudinal passages fixed by a second plane of spaced apart parallel strands forming in all a netting sheet. The angle between the first plane strands and the second plane strands can be any angel between 5 and 90 degree, such as between 30 and 90 degree, e.g. between 40 and 90 degree, such as between 40 and 50 degree or between 80 and 90 degree. Preferred are angles of about 45 degree and of about 90 degree. Most preferred are angles of about 90 degree.

The spacer medium can be oriented in any direction within the filter. The ends of the strands of the spacer medium at the end cap can form a angle with the end cap at anything between 5 and 175 degree, such as between 30 and 120 degree in a way that the strands of the spacer medium can be directed in any direction between away from and towards the core in the case of a circular filter as described elsewhere herein.

Core

In an embodiment the filter comprises at least one perforated core. The function of the core is to drain filtered liquid from the filter. Depending on the filter the filtered liquid is substantially free of contaminants or includes contaminants which can be removed by filtering through a filter with smaller pores.

The core can be produced of any material that can withstand the pressure which is obtained over the filtration medium and spacer medium, preferred is when the core is produced by polymer or metal. Polymers described elsewhere herein may be used as long as the core can withstand the pressure within the filter when in function.

To led filtered water from the filtration medium to the core, the core comprises apertures. The shape of the apertures can be any possible shapes such as round, hexagonal, pentagonal, quadrangular, triangular, starshaped. Preferred is when these apertures are substantially round or substantially quadrangular.

The apertures of the core each have a dimension of about 0.25 μM², such as about 0.5 mM², e.g. about 1 mM², such as about 2 mM², e.g. about 3 mM², such as about 4 mM², e.g. about 5 mM², such as about 6 mM², e.g. about 7 mM², such as about 8 mM², e.g. about 9 mM², such as about 10 mM², e.g. about 11 mM², such as about 12 mM², e.g. about 13 mM², such as about 14 mM², e.g. about 15 mM², such as about 16 mM², e.g. about 17 mM², such as about 18 mM², e.g. about 19 mM², such as about 20 mM², e.g. about 25 mM², such as about 30 mM², e.g. about 35 mM², such as about 40 mM², such as about 45 mM², e.g. about 50 mM², such as about 55 mM², e.g. about 60 mM², such as about 70 mM², such as about 80 mM², e.g. about 90 mM², such as about 100 mM², e.g. about 120 mM², such as about 140 mM², e.g. about 160 mM², such as about 180 mM², e.g. about 200 mM². Preferred is apertures of 0.5-100 mM². More preferred is apertures of 1-50 mM². Most preferred is apertures of 20-40 mM².

The apertures as described above can be evenly or un-evenly distributed throughout the surface of the core. Preferred is when the apertures are evenly distributed throughout the surface of the core. The apertures can occupy a small or larger area of the core, the apertures can comprises about 5-95% of the surface area of said core, such as 5-10%, e.g. 10-15%, such as 10-20%, e.g. 20-30%, such as 30-40%, e.g. 40-50%, such as 50-60%, e.g. 60-70%, such as 70-80%, e.g. 80-95. Preferred is when the apertures comprises 20-30% of the surface area of the core. Most preferred is when the apertures comprises 25% of the surface area of the core.

It is of outmost importance the core is stable to keep shape under function of the filter to ensure the structure of the filter and by this that no contaminated liquid can enter into the core. The material and number as well as size of the aperture are selected to ensure the stability of the core.

In an embodiment the core drains filtered liquid from the filter. The contaminated liquid enters the filter from the outside or through perforations of said end cap or into filtration medium or spacer medium from said bypass spaces. The filtration medium and/or spacer medium withold contaminants of the contaminated liquid, and eventually the filtered liquid enters into the core.

Cylindrical Filter

In an embodiment the at least one filtration medium and the at least one spacer medium are overlying one another and spirally surrounding the central core. Hereby the filter becomes cylindrical. More than one core can be placed within the cylindrical filter. It is preferred that the filter comprises one perforated central core.

A cylindrical filter can be constructed when the at least one filtration medium and the at least one spacer medium is one layer of filtration medium and one layer of spacer medium. Hereby one layer of filtration medium and one layer of spacer medium is placed on each other and rolled around a core.

To ensure the contaminated liquid is filtered the at least one filtration medium form an inner zone adjacent to said core, comprising a zone without said spacer medium. The inner zone can comprises at least 1 round of said filtration medium, but also the inner zone may comprises at least 2 rounds of said filtration medium, such as at least 3 rounds, e.g. at least 4 rounds, such as at least 5 rounds, e.g. at least 6 rounds, such as at least 7 rounds, e.g. at least 8 rounds, such as at least 9 rounds, e.g. at least 10 rounds. Preferred is an inner zone of 1-5 rounds of filtration medium, more preferred is 1-4 rounds of filtration medium, most preferred is 1-3 rounds of filtration medium in the inner zone.

The inner zone of the filter can have different thickness due to the numbers of rounds of filtration medium in this zone, also the thickness of the filtration medium determines the thickness of the inner zone. The inner zone comprises about 0.05-15 cm, such as about 0.06-10 cm, e.g. about 0.07-5 cm, such as about 0.08-10 cm, e.g. about 0.09-5 cm, such as about 0.1-4 cm, e.g. about 0.1-3 cm, such as about 1-2 cm, e.g. about 2-3 cm, such as about 3-4 cm, e.g. about 4-5 cm, such as about 5-6 cm, e.g. about 6-8 cm, such as about 8-10 cm, e.g. about 10-12 cm, such as about 12-15 cm. Preferred is a thickness of the inner zone of 3-8 cm. More preferred is about 5-6 cm. Most preferred is about 5.4 cm.

The thickness of the inner zone can comprise from 0.1-100% of the total thickness of the filtration medium and spacer medium, such as 0.1-10%, e.g. 10-20%, such as 20-30%, e.g. 30-40%, such as 40-50%, e.g. 50-60%, such as 60-70%, e.g. 70-80%, such as 80-90%, e.g. 90-100%. Preferred is 20-40%. More preferred is 30-40%. Most preferred is about 33%.

Further to ensure filtration of the contaminated liquid through at least the inner zone, the end cap is closed in the area of said inner zone, and perforated in the area outside of said inner zone. Hereby the contaminated liquid is forced to enter into the spacer medium and/or filtration medium in the area outside of the inner zone.

In one embodiment the end cap is closed in the area of said inner zone and is further closed in part of the area comprising filtration medium and spacer medium, and no bypass spaces is located beneath said areas where the end cap is closed. Hereby the contaminated liquid is forced to enter into the spacer medium and/or filtration medium in the area outside of the inner zone.

Compounds and/or Particles to be Removed from a Contaminated Liquid

The contaminated liquid can be any liquid with compounds and/or particles which is to be removed from the liquid in part or substantially total. Preferred is when the contaminated liquid is water contaminated with one or more compounds and/or particles. The compounds and/or particles can be any compounds and/or particles that can be removed from the liquid by passing the liquid through a filter. The compounds and/or particles can be caught by the spacer medium and/or filtration medium due to absorption and/or adsorption and/or caught by the pores of the spacer medium and filtration medium.

The filter can as mentioned above remove any compounds and/or particles from a liquid, preferred is filtering of compounds and/or or particles selected from the group of oil, sand, soil particles, bacteria, yeast, organic flocculation, dust, plant parts, plant nutrient. More preferred is compounds and/or particles selected from the group of organic liquids such as oil or hydrocarbons e.g. synthetic oils and fuels, coolants, paints, polymers, alcohols, solvents, aromatics, heavy metals, sewage, insecticides, herbicides, ochre, humus. The heavy metals can be any selected among nickel, lead, cadmium, mercury, chromium, molybdenum, manganese, iodine, copper, silver and gold.

The oils to be removed by filtration can be but are not limited to the common fuels: No. 2 Diesel fuel®, No. 6 Diesel fuel®, Kerosene®, Bunker C®, DF-A Artic®, DF-2 General®, DF-1 Low temp®, F-76 Diesel®, NPD Mgo®, Diesel Fuel Marine (DFM)®, Naval distillate fuel NDF, MIL-F-16884H®, Gasoline®, Burner Fuel oil—ASTM D396 STD Spec fuel oil®, AVGas®, JP-4 Jet fuel®, F-44 (JP-5)®, JP-5 Jet Fuel®, JP-7 Jet Fuel®, JP-8 Aviation Turbine®, JP-5/JP-8 Standard—MIL-T-5624P Aviation Turbine Fuel®.

Other oils that can be removed by filtration can be but are not limited to the common lube and hydraulic oils: 9250 L06 lube oil diesel®, MIL-L-9000H Lube Oil, Shipboard high output diesel, 2190 TEP LTL Lube Oil®, MIL-L-17331H Lube Oil Steam Turbine, ANSI/SAE J1899-95®, Motor Oil Automotive, HIL-H-5606® Hydroulic Fluid, MIL-L-23699 Aircraft Gas Turbine Synthetic Lubricant, MIL-H-17672D Hydraulic Fluid Petroleum, MIL-H-19457D Hydroulic Fluid Fire resistant, Transmission Fluid, Transformer Oil, Mineral Oil, Paraffin.

Flow Direction

The flow direction of contaminated liquid is exemplified by the flow direction in a cylindrical filter. In this filter the contaminated liquid may enter the filter through the spacer medium or through the filtration medium either perpendicular to the direction of the core or parallel to the direction of the core by entering the filtration medium or space medium from bypass spaces. The bypass spaces can be entered through the perforations of the end cap or parallel by the end cap, or bypass spaces inside a sealing is entered from the filtration medium or spacer medium.

The liquid which has entered the filtration medium and/or spacer medium and thus enter a bypass space and further again enters the filtration medium and/or spacer medium closer to the core is re-mixed with liquid passing through filtration medium and spacer medium.

Inside the filter the liquid can flow in any direction, except for outward, the flow in the filter eventually lead the liquid to the core. The liquid can flow in the coiled spacer medium to the inner zone of filtration medium, it can flow partly in the filtration medium and then pass through filtration medium and spacer medium more or less perpendicular to the core. The flow direction may be determined by the local pressure and deposited contaminants within the filtration medium and/or spacer medium. Deposited contaminants can be caught inside filtration medium or spacer medium or adsorbed to the surface on the filtration medium and/or spacer medium.

In the following text the area just inside a sealing is denoted ‘beneath a sealing’ no matter what way the filter has been oriented when in use, hereby ‘beneath a sealing’ may actually be ‘above a sealing’ when focus is on the lower side of a filter that is vertically orientated when in use. When a filter with bypass space and sealings between the end cap and edges of filtration medium and spacer medium is in use to filtrate liquid contaminated with substances which is visible at least in more concentrated form than in the liquid, the first visible sign of deposition of contaminants is small V-shaped formations of contaminants deposited in and/or on the spacer medium and/or the filtration medium beneath the sealings. As the filter is in use these V-shaped formation of contaminants enlarges and as they reach the opposite side of the filtration medium and spacer medium, the deposition area of contaminants becomes band-like areas. Further use of the filter will result in fusion of deposition areas and eventually the depositions of contaminants will be on the entire spacer medium and/or filtration medium.

Surprisingly the filter is not plugged with contaminants from the fluid in the filtration medium and/or spacer medium beneath the sealings of the end cap.

Filter Cartridge

In another aspect a filter cartridge comprises a filter as describe herein above wherein said filter cartridge is used in a filter house. A filter cartridge is layers of filtration medium and layers of spacer medium connected to an end cap. In case the filter is a rolled filter, a filter cartridge is a core surrounded by at least one layer of filtration medium and optionally at least one layer of spacer medium, where said layers of filtration medium and layers of spacer medium, if any, are closed at the edges of the layers by an end cap. The filter cartridge is a unit that is easy to handle, and which is assembled to stay together when handled.

In one aspect the invention relates to a filter cartridge comprising an exchangeable unit of a filter for liquid filtration, said filter comprises
at least two layers of filtration medium, comprising
   at least one inner layer of filtration medium and
   at least one outer layer of filtration medium,
   wherein each layer has at least one edge and a filtering area, and
wherein said at least two layers of filtration medium constitute a separation of a volume for non-filtered liquid and a volume for filtered liquid, and
wherein a first sealing is positioned outside of at least one edge of said at least one inner layer of filtration medium, and said first sealing directs liquid to be filtered through the filtering area of said at least one inner layer of filtration medium having the sealing, and wherein
the liquid to be filtered enters the filtration material
   through the filtering area of said at least one outer layer of filtration medium and/or
   through said edge of said at least one outer layer of filtration medium and/or
   between two adjacent edges of layers of filtration medium.

In an embodiment the filter cartridge may comprises features of the filter described elsewhere herein.

Filter House

In a further aspect a filter house comprises at least one filter cartridge as described herein above. The function of the filter house is to encapsulate the filter cartridge. In the area inside the filter house and surrounding the encapsulated filter cartridges contaminated liquid can be deposited, this comprises a sump. A pressure within the filter house ensure a flow of liquid from the sump through the filter to the core, through which core the filtered liquid is removed. When the filter house is in function it acts as a fluid-tight pressure vessel.

Another aspect of the invention relates to a filter house comprising at least one filter cartridge with a filter, said filter comprising
at least two layers of filtration medium, comprising
   at least one inner layer of filtration medium and
   at least one outer layer of filtration medium,
   wherein each layer has at least one edge and a filtering area, and
wherein a first sealing is positioned outside of at least one edge of said at least one inner layer of filtration medium, and said first sealing directs liquid to be filtered through the filtering area of said at least one inner layer of filtration medium having the sealing, and wherein
the liquid to be filtered enters the filtration material
   through the filtering area of said at least one outer layer of filtration medium and/or
   through said edge of said at least one outer layer of filtration medium and/or
   between two adjacent edges of layers of filtration medium.

The filter house can encapsulate at least one filter cartridge, e.g. at least 2 filter cartridges, such as at least 3 filter cartridges, e.g. at least 4 filter cartridges, such as at least 5 filter cartridges, e.g. at least 6 filter cartridges, such as at least 7 filter cartridges, e.g. at least 8 filter cartridges. Hereby the number of filter cartridges within a filter house can be e.g. 1, 2, 3, 4, 5, 6, 7, and 8. Preferred is 1, 2, 3, 4, 5, 6 filter cartridges within a filter house, more preferred is 1, 2, 3, 4 filter cartridges within a filter house, most preferred is 1 or 4 filter cartridges within a filter house.

In the filter house wherein 2 and more filter cartridges are used, the filter cartridges are stacked and the core from each filter cartridges are connected to perform a draining tube to drain off said filtered liquid.

The filter house comprises a container, which has at least one opening means through which the filter cartridges can be changed. The opening means can be in the side, top or bottom of the filter house. Preferred is openings means in the top of the filter house. Further the filter house comprises at least one entry for contaminated liquid and at least one exit for the draining tube which is connected to the cores of the filters.

The filter house with filter cartridges is partly or fully filled with contaminated liquid, and the inside of the filter house is exposed to pressure of about 0.1-6 Bar, such as about 0.5-5 Bar, e.g. about 1-4 Bar, such as about 2-3.5 Bar, e.g. about 1 Bar, such as about 1.5 Bar, e.g. about 2 Bar, such as about 2.5 Bar, e.g. about 3 Bar, such as about 3.5 Bar, e.g. about 4 Bar, such as about 4.5 Bar, e.g. about 5 Bar, such as about 5.5 Bar, e.g. about 6 Bar. Preferred is 1-4 Bar, more preferred is a pressure about 3 Bar.

The filter cartridges inside the filter house are connected by one or more draining tube which are sealed, thus no contaminated liquid can pass into the draining tube. The draining tube further comprises the perforated core inside the filter cartridges and said perforated cores are connected by packings. To ensure no contaminated liquid enters the core or draining tube the core of the filter cartridges situated at the top of each stack of filter cartridges are closed at the end of the core not connected to another filter cartridge, or the upper filter cartridge is connected to a second draining tube.

The filter house can have any shape e.g. a box or barrel. Preferred is when the filter house is barrel shaped.

The filter house can have any dimension. When the filter house is barrel shaped it can have a diameter between 50 and 1000 mM, such as between 100 and 900 mM, e.g. between 200 and 800 mM, such as between 300 and 700 mM, e.g. between 400 and 600 mM such as between 450 and 550 mM, e.g. between 475 and 525 mM, such as about 500 mM.

Further the diameter of the barrel shaped filter house can be about 50-100 mM, about 100-150 mM, about 150-200 mM, about 200-250 mM, about 250-300 mM, about 300-350 mM, about 350-400 mM, about 400-450 mM, about 450-500 mM, about 500-550 mM. Preferred is a diameter about 400-450 mM, about 450-500 mM, and about 500-550 mM, more preferred is a diameter about 450-500 mM and about 500-550 mM. Most preferred is a diameter about 450-500 mM.

The filter house as described herein has a height of at least about 100 mM, such as at least about 200 mM, e.g. at least about 300 mM, such as at least about 400 mM, e.g. at least about 500 mM, such as at least about 600 mM, e.g. at least about 700 mM, such as at least about 800 mM, e.g. at least about 900 mM, such as at least about 1000 mM, e.g. at least about 1200 mM, such as at least about 1300 mM, e.g. at least about 1400 mM, such as at least about 1500 mM, e.g. at least about 1600 mM, such as at least about 1700 mM, e.g. at least about 1800 mM, such as at least about 1900 mM, e.g. at least about 2000 mM, such as at least about 2100 mM, e.g. at least about 2200 mM.

Further the height of the filter house can be about 100 mM, about 200 mM, about 300 mM, about 400 mM, about 500 mM, about 600 mM, about 700 mM, about 800 mM, about 900 mM, about 1000 mM, about 1100 mM, about 1200 mM, about 1300 mM, about 1400 mM, about 1500 mM, about 1600 mM. Preferred is a height of about 300 mM, about 500 mM, and about 1100 mM. More preferred is a height of about 500 mM, and about 1100 mM. Most preferred is a height of about 1100 mM

As describes herein above the contaminated liquid when entering the filter house is situated within a sump. The contaminated liquid can enter the sump from above, from the side or from the bottom. The contaminated liquid of the sump is kept in motion to avoid contaminants to sediment. When the contaminated liquid enters the sump from the bottom, the supply of this liquid makes the motion. The motion of the contaminated liquid can also be performed by stirring, boiling and/or gas permeation. Preferred is gas permeation to keep the contaminated liquid of the sump to be in motion. More preferred is when the supply of the liquid makes the motion.

To regulate the pressure of the filter house, the filter house comprises pressure regulation means to adjust the pressure to a predetermined level as described elsewhere herein.

When in function, contaminated fluid is pumped into the filter house through the entry, and inwardly through the filter cartridge to produce filtered fluid, which then exits first the filter cartridge through the core and draining tube and then the filter house through the outlet.

The filtration rate of contaminated liquid is dependent of the compounds and particles to be removed. For heavy metals a low filtration rate is used corresponding to a long retention time.

Due to a high filter capacity of the filter cartridge described herein above the filtration rates of contaminated liquid to be filtered is about 0.05-6.5 M³ per hour, such as about 0.05-0.5 M³ per hour, e.g. about 0.5-1.0 M³ per hour, such as about 1.0-1.5 M³ per hour, e.g. about 1.5-2.0 M³ per hour, such as about 2.0-2.5 M³ per hour, such as about 2.5-3.0 M³ per hour, e.g. about 3.0-3.5 M³ per hour, such as about 3.5-4.0 M³ per hour, e.g. about 4.0-4.5 M³ per hour, such as about 4.5-5.0 M³ per hour, e.g. about 5.0-5.5 M³ per hour, such as about 5.5-6.0 M³ per hour, e.g. about 6.0-6.5 M³ per hour. Preferred is about 0.5-2.5 M³ per hour. More preferred is about 0.5-2.0 M³ per hour. Most preferred is about 1.0-1.5 M³ per hour

Filtration Systems with More Filter Houses

In another aspect a filtration system comprises at least two filter houses according to the above descriptions, wherein the at least two filter houses are connected in the way that contaminated liquid is filtered successively in the at least two filter houses, and where the contaminated liquid enters in a filter house no. 1 and the draining tube of filter house no. 1 is connected to the entry of filter house no. 2 and so forth.

In the filtration system the at least two filter houses graduates the filtration due to larger pores of filtration medium and spacer medium within filter house no. 1 than within succeeding filter houses and where the pores of the filtration medium and spacer medium are graded in the succeeding filter houses.

To optimise the filtration system contaminated liquid can be conveyed from the outside to any of the filter houses.

Production

An aspect of the invention relates to a method for the production of a filter, filter cartridge and/or filtration system according to the descriptions herein above.

A cylindrical filter can be produced by rolling one oblong layer of filtration medium and one oblong layer of spacer medium simultaneously around a central core. The width of the filtration medium and spacer medium correspond to the height of the filter. To ensure filtration of the contaminated liquid the inner part as described herein elsewhere is filtration medium. The outermost part of the filter can be filtration medium or spacer medium. The length and subsequent the thickness of the oblong layers of spacer medium and filtration medium determines the thickness of the filter.

The spacer medium may be wider than the filtration medium when the layers are placed upon each other before wrapped around the core, in this way the layers of spacer medium becomes higher than the layers of filtration medium when the filter is constructed as a cylindrical filter. The sealing between the end cap and layers of filtration medium and spacer medium must at least partly reach the edge of the filtration medium. Within the inner zone only filtration medium is used. This inner zone can be as wide as the spacer medium, or as wide as the filtration medium outside the inner zone of the filter. The end cap above the inner zone is sealed to ensure no contaminated liquid can bypass the filtration medium of the inner zone.

The filtration medium and spacer medium can have uniform porosity throughout the filter or one or both of filtration medium and spacer medium can have a graded porosity with smaller pores in the inner part of the filter.

The filter can also be constructed from oblong layers of filtration medium and spacer medium where one or both kind of medium is not long enough to constitute the entire layer of the medium. A new layer of filtration medium and/or spacer medium can be initiated with or without an overlapping layer of the ending layer of filtration medium and/or spacer medium. To continue a layer of ended spacer medium it is preferred that two ends of layers of spacer medium are overlapping.

Further the filter can be constructed from one or more oblong layers of spacer medium with short layers of filtration medium wrapped together with the spacer medium. Distance can be employed between the layers of filtration medium. The inner zone of the filter must be filtration medium.

A filter can also be constructed with more than one layer of filtration medium and/or spacer medium, which are wrapped around a core in case the filter is cylindrical, and which is stacked in case the filter is box-shaped, examples of this layered structures are:
Filtration medium 1 and spacer medium 1.
Filtration medium 1, spacer medium 1, filtration medium 2, and spacer medium 2.
Filtration medium 1, spacer medium 1, filtration medium 2, spacer medium 2, filtration medium 3, spacer medium 3.
Filtration medium 1, spacer medium 1, and spacer medium 2.
Filtration medium 1, spacer medium 1, and filtration medium 2.
Filtration medium 1, spacer medium 1, spacer medium 2, and filtration medium 2.
Filtration medium 1, spacer medium 1, spacer medium, 2 filtration medium 2 and spacer medium 3.

Wherein the innermost layer of the cylindrical filter is filtration medium. Different numbers of filtration medium and/or spacer medium may indicate different porosity of the layers and/or different materials of the layers.

One aspect of the invention relates to a method of producing a filter, comprising the steps of
providing at least one layer of filtration medium,
organise said at least one layer of filtration medium to acquire
   at least one inner layer of filtration medium and
   at least one outer layer of filtration medium,
   wherein each layer has at least one edge and a filtering area, and
sealing at least one of said edges in a manner where a first sealing seals the at least one edge of said at least one inner layer of filtration medium, so that said first sealing directs liquid to be filtered through the filtering area of said at least one inner layer of filtration medium having the sealing, and wherein
obtaining a filter where the liquid to be filtered enters the filtration material
   through the filtering area of said at least one outer layer of filtration medium and/or
   through said edge of said at least one outer layer of filtration medium and/or
   between two adjacent edges of layers of filtration medium.

Another aspect of the invention relates to a method of producing a filter cartridge comprising the steps of
providing at least one layer of filtration medium,
organise said at least one layer of filtration medium to acquire
   at least one inner layer of filtration medium and
   at least one outer layer of filtration medium,
   wherein each layer has at least one edge and a filtering area, and
wherein said at least two layers of filtration medium constitute a separation of a volume for non-filtered liquid and a volume for filtered liquid, and
sealing at least one of said edges in a manner where a first sealing seals the at least one edge of said at least one inner layer of filtration medium, so that said first sealing directs liquid to be filtered through the filtering area of said at least one inner layer of filtration medium having the sealing, and wherein
obtaining a filter where the liquid to be filtered enters the filtration material
   through the filtering area of said at least one outer layer of filtration medium and/or
   through said edge of said at least one outer layer of filtration medium and/or
   between two adjacent edges of layers of filtration medium.

A further aspect of the invention relates to a method of producing a filtration system comprising the steps of
providing at least one filter cartridge according to claim 67,
providing at least one filter house according to claim 69-84,
organising said at least one filter cartridge into said at least one filter house,
providing an inlet into said at least one filter house for non-filtered liquid, said inlet being in contact with a volume for non-filtered liquid,
providing an outlet from said at least one filter house for filtered liquid, said outlet being in contact with a volume for filtered liquid, wherein said volume for non-filtered liquid and said volume for filtered liquid is connected by at least two layers of filtration medium, comprising
   at least one inner layer of filtration medium and
   at least one outer layer of filtration medium,
   wherein each layer has at least one edge and a filtering area, and
      wherein a first sealing seals at least one edge of said at least one inner layer of filtration medium, and said first sealing directs liquid to be filtered through the filtering area of said at least one inner layer of filtration medium having the sealing, and wherein
      the liquid to be filtered enters the filtration material
         through the filtering area of said at least one outer layer of filtration medium and/or
         through said edge of said at least one outer layer of filtration medium and/or
         between two adjacent edges of layers of filtration medium.
            Use

An aspect of the invention relates to the use of a filter, where said filter comprising at least two layers of filtration medium, comprising
at least one inner layer of filtration medium and
at least one outer layer of filtration medium,
wherein each layer has at least one edge and a filtering area, and
wherein a first sealing seals at least one edge of said at least one inner layer of filtration medium, and said first sealing directs liquid to be filtered through the filtering area of said at least one inner layer of filtration medium having the sealing, and wherein
the liquid to be filtered enters the filtration material
   through the filtering area of said at least one outer layer of filtration medium and/or
   through said edge of said at least one outer layer of filtration medium and/or
      between two adjacent edges of layers of filtration medium.

Another aspect relates to the use of a filter, filter cartridge and/or filtration system according to the descriptions herein above.

An aspect relates to the use of a filter, filter cartridge and/or filtration system according to the descriptions herein above for filtering contaminated liquid according to the description above.

An embodiment relates to the use of a filter, filter cartridge and/or filtration system according to the descriptions herein above for filtering contaminated liquid within areas selected from the group of factories, sewage works, paint factories, paper factories, ships. Preferred is filtering water contaminated with oil at ships. Preferred is ships selected from the group of oil tanker, transport ship, ferry, fishing vessel, container carrier, car carrier, feeder ship, Ro/Ro container, tanker, bulk carrier, tug Ro/Ro car transporter, V.L.C.C., FPSO, OBO carrier, passenger car ferry, ferry, dredger, cable layer, LPG layer, support vessel, fish carrier, cruise liner, frigat, aircraft carrier, helicopter carrier, sentinel 11, offshore support, ice breaker, vehicle cargo ship, fleet oiler, oil rig supply tug, drill platform, LPG carrier, dredger, floating storage barge.

The use of the filter, filter cartridge and/or filtration system according to the descriptions herein above for filtering contaminated liquid can be used at any ship independent of the size. The filter, filter cartridge and/or filtration system ships can be registered to above at least 50 gross register tonnnage, such as at least 400 register tonnnage, e.g. at least 700 register tonnnage, such as at least 1,000 register tonnnage, e.g. at least 1,500 register tonnnage, such as at least 2,000 register tonnnage, e.g. at least 5,000 register tonnnage, such as at least 10,000 register tonnnage, e.g. at least 20,000 register tonnnage, such as at least 40,000 register tonnnage, e.g. at least 60,000 register tonnnage, such as at least 80,000 register tonnnage, e.g. at least 100,000 register tonnnage. Preferred is use of the filter, filter cartridge and/or filtration system to ships of at least 400 register tonnnage, more preferred is at least 700 register tonnnage, most preferred is at least 1,500 register tonnnage.

When using the filter, filter cartridge and/or filtration system according to the descriptions herein above for filtering contaminated liquid, the filtered water can be discharged to areas selected from the group of: land, river, sea, ocean, harbour.

Preferred is discharging filtered water to the sea or ocean. Preferred is to use filter, filter cartridge and/or filtration system according to the descriptions herein above for filtering water contaminated with oil at ships, where the amount of oil in the filtered water is less than about 25 ppm, such as less than about 20 ppm, e.g. less than about 15 ppm, such as less than about 14 ppm, e.g. less than about 13 ppm, such as less than about 12 ppm, e.g. less than about 11 ppm, such as less than about 10 ppm, e.g. less than about 9 ppm, such as less than about 8 ppm, e.g. less than about 7 ppm, such as less than about 6 ppm, e.g. less than about 5 ppm, such as less than about 4 ppm, e.g. less than about 3 ppm, such as less than about 2 ppm, e.g. less than about 1 ppm. Preferred is less than about 15 ppm. More preferred is less than about 10 ppm. Most preferred is less than about 5 ppm.

### EXAMPLES

### Example 1

The hydrophobic cellulose fibres are made hydrophobic by the following process:

The cellulose fibre sheet is dipped in a solution of 5-50% hydrophobic emulsion (e.g. 200 G resin emulsion per litre water=20%) for about ½-5 minutes. By passing the sheet through a roll, the water is pressed out of the cellulose sheet. Hereafter the sheet is dipped in a 1-30% solution of potassium/sodium sulphate (e.g. 20 G alum per litre water=2%) for about ½-5 minutes. After pressing out the water of the cellulose sheet by a roll, the process is followed by a drying process in an oven (110 degree C./20 minutes).

### Example 2

A filter cartridge (test cartridge 1) utilising spacer medium and filtration medium according to the present disclosure but without the inner zone, mounted with annular end caps bonded totally to the ends of the filter, exhibits a filter life approximately two times greater than a control filter cartridge (control filter cartridge) wrapped with only filtration medium.

Visual inspection and dissection of the filter cartridge (test cartridge 1) shows a contaminant loading corresponding to a radial flow from the outermost layer to the central coil covering about 10-15% of the filter. In comparison only the outermost layer of filtration medium displayed contaminant loading in control filter (control filter cartridge), covering about 2-5% of the filter.

### Example 3

A filter cartridge (test cartridge 2) utilising only filtration medium, mounted with annular end caps with two circle packing, this filter exhibits a filter life 1½ times better than a control cartridge (control filter cartridge) having end caps totally bonded to the ends of the filter.

Visual inspection and dissection of the filter cartridge shows a contaminant loading corresponding to a radial flow from the outermost layer to the central coil covering about 25% of the filter.

### Example 4

A filter cartridge (test cartridge 3) utilising spacer medium and filtration medium according to the present disclosure but without inner zone, mounted with annular end caps with two circle packing, exhibits a filter life 3 times better than a control filter cartridge (control filter cartridge 1).

A visual inspection and dissection of the filter cartridge medium showed a contaminant loading corresponding to a radial and longitudinal flow from the outermost layer to the central coil covering about 50% of the filter.

### Example 5

A filter cartridge (test cartridge 4) utilizing spacer medium and filtration medium according to the present disclosure but without inner zone, mounted with annular end caps with perforated zones and two circle packing, exhibits a filter life 5 times greater than a control filter (control filter cartridge 1).

A visual inspection and dissection of the filter cartridge medium showed a contaminant loading corresponding to a radial and longitudinal flow from the outermost layer to the central coil covering about 80% of the filter.

### Example 6

A filter cartridge (test cartridge 5) utilizing spacer medium and filtration medium according to the present disclosure wrapped without spacer medium in the inner part of the filter cartridge, mounted with annular end caps with perforated zones and two circle packing, exhibits a filter life 5-6 times greater than a control filter

A visual inspection and dissection of the filter cartridge medium showed a contaminant loading corresponding to a radial and longitudinal flow from the outermost layer to the central coil covering about 80-90% of the filter.

Thus the combination of modified annular end caps, spacer material and inner zone as described for test cartridge 4 provides a synergetic effect that was not to be expected based upon the performances of test cartridge 2.

The examples 2-6 are summarised in the following table:

| | | | Inner | | | Contaminant | Filter capacity, |
|---|---|---|---|---|---|---|---|
| | | | zone | | End | loading | relative to the |
| | | | only of | | cap | of the | amount filtered |
| | Filtration | Spacer | filtration | Bypass | with | filtration | by the ‘control |
| Filter type | medium | medium | medium | spaces | perforations | medium | filter cartridge’ |
| Control | + | − | − | − | − | 2-5% | 1 |
| filter cartridge | | | | | | | |
| Test filter | + | + | − | − | − | 10-15% | 2 |
| cartridge 1 | | | | | | | |
| Test filter | + | − | − | + | − | 25% | 1.5 |
| cartridge 2 | | | | | | | |
| Test filter | + | + | − | + | − | 50% | 3 |
| cartridge 3 | | | | | | | |
| Test filter | + | + | − | + | + | 80% | 5 |
| cartridge 4 | | | | | | | |
| Test filter | + | + | + | + | + | 80-90% | 5-6 |
| cartridge 5 | | | | | | | |

### Example 7

Test of Filter

A filter system containing four filter cartridges was fed with a mixture of oil/water with a concentration of approx 100 ppm. oil. Test samples have been selected before and after the filter in accordance with submitted test procedures.

Each filter cartridges was constructed as a rolled filter with the dimensions of 24 cm in height and 38 cm in diameter. 33 meter filtration medium and 28 meter spacer medium was used for each filter. The filtration medium and spacer medium were rolled around a core 32 mm in diameter.

The filtration medium was made of high density polyethylene, it was 225 mm in width and 2.4 mm in thickness with a tolerance of 0.1 mm, the average pore size was 38 μm.

The spacer medium was polypropylene with 32*25 mm meshes in parallelograms, 225 mm in width.

The filtration medium and spacer medium was rolled around a core of polypropylene with apertures. The inner part of the filter up to 7 cm from the centre of the core was only with filtration medium, from here corresponding approximately to the position of the inner sealing the spacer medium was rolled together with the filtration medium.

The cylindrical filter was in each end covered with a circular end cap of polypropylen. Two circular sealings incorporated in the end cap were positioned centrally with diameters of 140 mm and 260 mm, giving a position of sealings at 7 and 13 cm from the centre of the end cap. The sealings were rectangular, 10 mm in height and 3 mm in width. The end cap was 5 cm in height, of which about 4 cm covered a part of the filtration area of the outermost layer of filtration medium. The end cap had perforations in the part outside of the outermost sealing. 20 circular perforations were located evenly at a distance 8 cm from the centre of the end cap. Each perforation was 5 mm in diameter. The end cap was positioned close to the edges of the layers of filtration medium and spacer medium resulting in by pass space varying from none to a few mm.

The filter house was a cylindrical shell with dished ends made from stainless steel. Outside diameter 500 mm and wall thickness 4 mm, height approx. 120 cm. The filter cartridges were removable. The filter house was provided with a pressure.

Three tests with different grades of oil, Shell Fuel Oil 45, Shell Fuel Oil 77 and Shell Marine Gas Oil W, were performed.

The oil was mechanically mixed with water and fed via a horse pump and flow meter through a centrifugal pump into the filter. The feed of oily water and sampling was carried out in accordance with submitted procedures.

Sampling and analyses of test samples was carried out by Miljølaboratoriet, Storkøbenhavn I/S, a laboratory accredited by the Danish Authorities, DANAK, for this type of testing.

The analyses were carried out to agreed procedures, GC-FID. The test reports shows that influent of approx. 100 ppm oil in water leaves the filter as effluent with less than or equal to 5 ppm oil in water.

Each filter cartridge could absorb approximately 3 kg of oil at an influent oil concentration of 100 ppm. Each filter cartridge could filtrate approximately 30 cubic meters of the water/oil blend, with an effluent with less than or equal to 5 ppm oil in water.

1-101. (canceled)

102. A filter for liquid filtration, said filter comprises:
at least two layers of filtration medium, wherein said two layers of filtration medium comprise:
at least one inner layer of filtration medium, and
at least one outer layer of filtration medium, and
wherein said outer layer of filtration medium is positioned outside of said inner layer of filtration medium in respect of a horizontal flow direction of liquid to be filtered, and
wherein a first sealing is positioned outside of said at least one inner layer of filtration medium and inside of said at least one outer layer of filtration medium, and
wherein the filtration mediums and sealing are arranged to allow the liquid to be filtered to enter the at least one outer layer of filtration medium and flow through said at least one inner layer of filtration medium.

103. The filter according to claim 102, wherein said at least one inner layer of filtration medium and said at least one outer layer of filtration medium each has a filtration area and at least one edge, said at least one edge being located at the area of said first sealing, and wherein said first sealing comprises a sealing prohibiting liquid to enter said at least one edge of said sealed at least one inner layer of filtration medium.

104. The filter according to claim 103, wherein said filter further comprising at least one layer of spacer medium, wherein said at least one layer of spacer medium has at least one edge and a spacer area, and wherein said at least one layer of spacer medium is provided between said at least one inner layer of filtration medium and said at least one outer layer of filtration medium with the spacer area of the spacer medium next to the filtration area of the filtration medium.

105. The filter according to claim 102, wherein said at least one layer of filtration medium alternate with said at least one layer of spacer medium with the repeated alternating structure of a filtration medium 1 and a spacer medium 1.

106. The filter according to claim 105, wherein the innermost layer of the filter is at least one layer of said at least one inner layer of filtration medium.

107. The filter according to claim 102, further comprising a number of additional sealings with distance to said first sealing and each with mutual distance, and wherein said additional sealings each seals one or more of the edges of said layers of filtration medium and/or of the edges of said spacer medium and where the edges of said filtration medium and said spacer medium between each sealing are unsealed.

108. The filter according to claim 102, wherein said sealing comprises an end cap and said end cap provide open spaces comprising bypass spaces between said sealings, where contaminated liquid or filtered liquid can enter said bypass spaces and further enter into said filtration medium and said spacer medium through said edges of said filtration medium and said spacer medium.

109. The filter according to claim 108, wherein said end cap further comprises perforations in the end cap itself in the area outside of the first sealing, and contaminated liquid can run through said perforations.

110. The filter according claim 104, wherein said filtration medium and said spacer medium have pores and the pores of the spacer medium are larger than the pores of the filtration medium.

111. The filter according to claim 110, wherein said pores are smaller in the inner layers of said filtration medium and/or said spacer medium than in the outer layers of said filtration medium and/or said spacer medium.

112. The filter according to claim 102, wherein said filtration medium is produced by a product selected from the group of polymers, paper, plant fibres, peat, humus, plastics, wool, cotton, rock wool, cellulose, coal fibre and/or glass wool.

113. The filter according to claim 112, wherein said filtration medium is produced by sheets of cellulose fibres and/or polymer fibre.

114. The filter according to claim 102, wherein said cellulose fibres are made hydrophobic by treatment with compounds selected from the group of wax, starch, natural resins, synthetic resins, water insoluble polyvinyl alcohol, hydroxyethyl cellulose, ethyl cellulose, carboxymethyl cellulose, polyacrylate resin, alkyd resin, polyester resin.

115. The filter according to claim 104, wherein said spacer medium is produced by a product selected from the group of polymers, paper, plant fibres, plastics, wool, cotton, rock wool, cellulose, coal fibre, metal and/or glass wool.

116. The filter according to claim 102, wherein the filter comprises at least one perforated core.

117. The filter according to claim 116, wherein the core is produced by polymer or metal.

118. The filter according to claim 116, wherein said core comprises apertures.

119. The filter according to claim 104, wherein the at least one filtration medium and the at least one spacer medium are overlying one another and spirally surrounding the central core.

120. The filter according to claim 116, wherein said at least one filtration medium form an inner zone adjacent to said core, comprising a zone without said spacer medium, and said inner zone comprises at least 1 round of said filtration medium.

121. The filter according to claim 108, wherein said end cap is closed in the area of said inner zone, and perforated in the area outside of said inner zone.

122. A filter house comprising at least one filter cartridge with a filter, said filter comprising:
at least two layers of filtration medium, wherein said two layers of filtration medium comprise:
at least one inner layer of filtration medium and
at least one outer layer of filtration medium, and
wherein said outer layer of filtration medium is positioned outside of said inner layer of filtration medium in respect of a horizontal flow direction of liquid to be filtered, and
wherein a first sealing is positioned outside of said at least one inner layer of filtration medium and inside of said at least one outer layer of filtration medium, and wherein
the filtration mediums and sealing are arranged to allow the liquid to be filtered to enter the at least one outer layer of filtration medium and flow through said at least one inner layer of filtration medium.

123. The filter house according to claim 122, wherein said at least one filter cartridge is at least 2 filter cartridges.

124. The filter house according to claim 122, wherein said filter house comprises a container, which has at least one opening means and through which at least one opening means said filter cartridges can be changed.

125. The filter house according to claim 122, wherein said filter house comprises at least one entry for contaminated liquid and at least one exit for a draining tube.

126. A method of producing a filter, comprising the steps of:
providing at least one layer of filtration medium,
organise said at least one layer of filtration medium to acquire
at least one inner layer of filtration medium and
at least one outer layer of filtration medium,
wherein said outer layer of filtration medium is positioned outside of said inner layer of filtration medium in respect of a horizontal flow direction of liquid to be filtered, and
sealing at least one of said inner layer of filtration medium, so that the filtration mediums and sealing are arranged to allow the liquid to be filtered to enter the at least one outer layer of filtration medium and flow through said at least one inner layer of filtration medium, and hereby
obtaining a filter.

127. Use of a filter according to claim 102.

128. The use according to claim 127 for filtering water contaminated with one or more compounds and/or particles selected from the group of oil, sand, soil particles, bacteria, yeast, organic flocculation, dust, plant parts, ochre, humus, plant nutrient.

129. The use according to claim 128 for filtering contaminated liquid within areas selected from the group of factories, sewage works, paint factories, paper factories, ships.

130. The use according to claim 129 for filtering water contaminated with oil at ships.
